(19) United States
(12) Patent Application Publication
(10) Pub. No.: US 2024/0118462 A1
(43) Pub. Date: Apr. 11, 2024

(54) BOKEH FILTER MEMBRANE, IMAGING OPTICAL LENS ASSEMBLY, IMAGING APPARATUS AND ELECTRONIC DEVICE

(71) Applicant: LARGAN PRECISION CO., LTD., Taichung City (TW)

(72) Inventors: Wen-Yu TSAI, Taichung City (TW); Cheng-Yu TSAI, Taichung City (TW); Chun-Hung TENG, Taichung City (TW)

(21) Appl. No.: 18/480,584

(22) Filed: Oct. 4, 2023

(30) Foreign Application Priority Data
Oct. 7, 2022 (TW) 111138232

(51) Int. Cl. G02B 5/02; G02B 1/115; G02B 5/22

(52) U.S. Cl. CPC G02B 5/0247; G02B 1/115; G02B 5/0294; G02B 5/22

(57) ABSTRACT

A bokeh filter membrane, which is disposed on a surface of a substrate, includes a gradient thickness absorbing membrane and an anti-reflection membrane. The anti-reflection membrane includes a high-and-low refraction membrane and a gradient refraction membrane. A transmittance of the substrate at a center thereof is greater than a transmittance of the substrate at a peripheral region thereof. The high-and-low refraction membrane includes a first high-and-low refraction membrane and a second high-and-low refraction membrane, the gradient thickness absorbing membrane is farther away from the substrate than the first high-and-low refraction membrane, the second high-and-low refraction membrane is farther away from the substrate than the gradient thickness absorbing membrane, and the gradient refraction membrane is farther away from the substrate than the second high-and-low refraction membrane. The gradient refraction membrane includes a plurality of pores. A main material of the gradient refraction membrane is metal oxide.

### RELATED APPLICATIONS

This application claims priority to Taiwan Application Serial Number 111138232, filed Oct. 7, 2022, which is herein incorporated by reference.

### BACKGROUND

### Technical Field

The present disclosure relates to an imaging optical lens assembly, an imaging apparatus and an electronic device. More particularly, the present disclosure relates to an imaging optical lens assembly, an imaging apparatus and an electronic device that include a bokeh filter membrane so as to reduce reflected light.

### Description of Related Art

In recent years, it has become more and more popular to use a miniature optical lens assembly of a mobile device for photographing. However, the optical lens assembly with a large aperture stop provides a brighter and clearer photography experience, but the depth of field thereof is shallower, resulting in the scene is defocused more seriously. Thus, the problem of secondary linear aberration in out-of-focus imaging cannot be solved, and it is easy to form clear and excessively overlapping light spots, so that certain interference will be developed, the imaged subject is unable to be highlighted, and the imaging quality thereof will be reduced.

In the prior, the surface of the optical lens element or the optical element in the optical lens assembly can be coated with a metal film that can absorb light so as to achieve the effects of soft peripheral bokeh and eliminating stray lights. Although it is favorable for enhancing the optical imaging quality, the effects thereof are still insufficient to eliminate the problem of high reflection in some areas.

### SUMMARY

According to one aspect of the present disclosure, a bokeh filter membrane, which is disposed on a surface of a substrate, includes a gradient thickness absorbing membrane and an anti-reflection membrane. The anti-reflection membrane includes a high-and-low refraction membrane and a gradient refraction membrane. A transmittance of the substrate at a center thereof is greater than a transmittance of the substrate at a peripheral region thereof. The high-and-low refraction membrane includes a first high-and-low refraction membrane and a second high-and-low refraction membrane, the gradient thickness absorbing membrane is farther away from the substrate than the first high-and-low refraction membrane, the second high-and-low refraction membrane is farther away from the substrate than the gradient thickness absorbing membrane, and the gradient refraction membrane is farther away from the substrate than the second high-and-low refraction membrane. The gradient refraction membrane includes a plurality of pores, and the pores away from the substrate are relatively larger than the pores close to the substrate. A main material of the gradient refraction membrane is metal oxide. When a membrane thickness of the gradient refraction membrane is TNG, the following condition is satisfied: 115.0 nm≤TNG≤1000.0 nm.

According to one aspect of the present disclosure, an imaging optical lens assembly includes the bokeh filter membrane according to the aforementioned aspect, at least one optical lens element and at least one optical element. At least one surface of the at least one optical lens element and the at least one optical element includes the bokeh filter membrane.

According to one aspect of the present disclosure, an imaging apparatus includes the imaging optical lens assembly according to the aforementioned aspect and an image sensor. The image sensor is disposed on an image surface of the imaging optical lens assembly.

According to one aspect of the present disclosure, an electronic device includes the imaging apparatus according to the aforementioned aspect.

According to one aspect of the present disclosure, a bokeh filter membrane, which is disposed on a surface of a substrate, includes a gradient thickness absorbing membrane and an anti-reflection membrane. The anti-reflection membrane includes a high-and-low refraction membrane and a gradient refraction membrane. A transmittance of the substrate at a center thereof is greater than a transmittance of the substrate at a peripheral region thereof. The gradient thickness absorbing membrane includes a first gradient thickness absorbing membrane and a second gradient thickness absorbing membrane, the second gradient thickness absorbing membrane is farther away from the substrate than the first gradient thickness absorbing membrane, and the gradient refraction membrane is farther away from the substrate than the second gradient thickness absorbing membrane. The gradient refraction membrane includes a plurality of pores, and the pores away from the substrate are relatively larger than the pores close to the substrate. A main material of the gradient refraction membrane is metal oxide. When a membrane thickness of the first gradient thickness absorbing membrane at a maximum effective diameter is Tab1, a membrane thickness of the second gradient thickness absorbing membrane at the maximum effective diameter is Tab2, and a total membrane thickness of the bokeh filter membrane at the maximum effective diameter is TKP, the following conditions are satisfied: 0.60≤Tab1/Tab2≤1.80; and 1250.0 nm<TKP.

According to one aspect of the present disclosure, an imaging optical lens assembly includes the bokeh filter membrane according to the aforementioned aspect, at least one optical lens element and at least one optical element. At least one surface of the at least one optical lens element and the at least one optical element includes the bokeh filter membrane.

### BRIEF DESCRIPTION OF THE DRAWINGS

The present disclosure can be more fully understood by reading the following detailed description of the embodiment, with reference made to the accompanying drawings as follows:

FIG. 1 is a relationship diagram between the reflectance and the wavelengths of a bokeh filter membrane including a gradient thickness absorbing membrane with different total membrane thicknesses according to Example 1.

FIG. 2 is a relationship diagram between the transmittance and the wavelengths of the bokeh filter membrane including the gradient thickness absorbing membrane with different total membrane thicknesses according to Example 1.

FIG. 3 is a schematic view of an imaging optical lens assembly according to Example 11 of the present disclosure.

FIG. 4 is a schematic view of an imaging optical lens assembly according to Example 12 of the present disclosure.

FIG. 5 is a schematic view of an imaging optical lens assembly according to Example 13 of the present disclosure.

FIG. 6 is a schematic view of an imaging optical lens assembly according to Example 14 of the present disclosure.

FIG. 7 is a schematic view of an electronic device according to Example 15 of the present disclosure.

FIG. 8 is a schematic view of an electronic device according to Example 16 of the present disclosure.

FIG. 9A is a schematic view of one side of an electronic device according to Example 17 of the present disclosure.

FIG. 9B is a schematic view of another side of the electronic device of FIG. 9A.

### DETAILED DESCRIPTION

One embodiment of the present disclosure provides a bokeh filter membrane, the bokeh filter membrane is disposed on a surface of a substrate, and the bokeh filter membrane includes a gradient thickness absorbing membrane and an anti-reflection membrane. The anti-reflection membrane includes a high-and-low refraction membrane and a gradient refraction membrane. A transmittance of the substrate at a center thereof is greater than a transmittance of the substrate at a peripheral region thereof. The high-and-low refraction membrane includes a first high-and-low refraction membrane and a second high-and-low refraction membrane, the gradient thickness absorbing membrane is farther away from the substrate than the first high-and-low refraction membrane, the second high-and-low refraction membrane is farther away from the substrate than the gradient thickness absorbing membrane, and the gradient refraction membrane is farther away from the substrate than the second high-and-low refraction membrane. The gradient refraction membrane includes a plurality of pores, and the pores away from the substrate are relatively larger than the pores close to the substrate. A main material of the gradient refraction membrane is metal oxide.

Therefore, the present disclosure develops the bokeh filter membrane with a multi-layer coating, the gradient thickness absorbing membrane that can absorb the visible light is added to the multi-layer coating, and the gradient thickness absorbing membrane is arranged in the method that the thickness thereof is distributed in the form of concentric circles at different positions on the substrate so as to produce differences in different positions. Accordingly, the transmittance gradually decreases from the center of the substrate to the peripheral region thereof, and it is favorable for adjusting the amount of light entering the peripheral region and then achieving the effect of soft edges of the defocused scenery, so that a higher contrast between the imaged subject and the soft bokeh background can be obtained, and the imaged subject can be more standing out. Further, the generation of stray light can be further reduced so as to enhance the optical imaging quality by the arrangement that a plurality of high refraction membranes and a plurality of low refraction membranes of the high-and-low refraction membrane are arranged by alternately, so that the light on the surface of the coating layer can be affected by the destructive interference so as to achieve the aim of reducing the reflected light. Furthermore, by the pores with a gradient change of size of the gradient refraction membrane and the gradient-changed refractive index as well as by controlling the gradient refraction membrane to meet a minimum membrane thickness limitation, it is favorable for maintaining a best pore structure and a continuous change of the refractive index, and an ultra-low reflection effect in the visible light wavelength range of each of the areas can be provided.

One embodiment of the present disclosure provides a bokeh filter membrane, the bokeh filter membrane is disposed on a surface of a substrate, and the bokeh filter membrane includes a gradient thickness absorbing membrane and an anti-reflection membrane. The anti-reflection membrane includes a high-and-low refraction membrane and a gradient refraction membrane. A transmittance of the substrate at a center thereof is greater than a transmittance of the substrate at a peripheral region thereof. The gradient thickness absorbing membrane includes a first gradient thickness absorbing membrane and a second gradient thickness absorbing membrane, the second gradient thickness absorbing membrane is farther away from the substrate than the first gradient thickness absorbing membrane, and the gradient refraction membrane is farther away from the substrate than the second gradient thickness absorbing membrane. The gradient refraction membrane includes a plurality of pores, and the pores away from the substrate are relatively larger than the pores close to the substrate. A main material of the gradient refraction membrane is metal oxide.

Therefore, by the arrangements that an absorbing membrane that can absorb the visible light is arranged in a multi-layer coating, and the membrane thicknesses of the first gradient thickness absorbing membrane and the second gradient thickness absorbing membrane are adjusted to maintain consistently, it is favorable for balancing the degree of absorption at all wavelengths in the range of the visible light. Further, the thickness of the bokeh filter membrane is arranged to distribute in the form of concentric circles at different positions on the substrate so as to produce differences in different positions, so that the transmittance gradually decreases from the center of the substrate to the peripheral region thereof. Accordingly, it is favorable for adjusting the amount of light entering the peripheral region and then achieving the effect of soft edges of the defocused scenery.

When a membrane thickness of the gradient refraction membrane is TNG, the following condition is satisfied: 115.0 nm TNG 1000.0 nm. Therefore, by controlling the membrane thickness of the gradient refraction membrane, an optimal pore structure can be maintained, and it is favorable for effectively avoiding the reduction of anti-reflection effect caused by the insufficient membrane thickness. Furthermore, the following condition can be satisfied: 116.0 nm TNG 800.0 nm. Furthermore, the following condition can be satisfied: 116.0 nm TNG 600.0 nm. Furthermore, the following condition can be satisfied: 116.0 nm TNG 500.0 nm. Furthermore, the following condition can be satisfied: 117.0 nm TNG 500.0 nm. Furthermore, the following condition can be satisfied: 118.0 nm TNG 400.0 nm. Furthermore, the following condition can be satisfied: 118.0 nm TNG 350.0 nm.

When a membrane thickness of the first gradient thickness absorbing membrane at a maximum effective diameter is Tab1, and a membrane thickness of the second gradient thickness absorbing membrane at the maximum effective diameter is Tab2, the following condition can be satisfied: 0.60≤Tab1/Tab2≤1.80. Therefore, by controlling the membrane thickness of the first gradient thickness absorbing membrane and the second gradient thickness absorbing membrane to maintain consistently, it is favorable for balancing the degree of absorption at all wavelengths in the range of the visible light. Furthermore, the following condition can be satisfied: 0.70≤Tab1/Tab2≤1.60. Furthermore, the following condition can be satisfied: 0.80≤Tab1/Tab2≤1.40. Furthermore, the following condition can be satisfied: 0.85≤Tab1/Tab2≤1.30. Furthermore, the following condition can be satisfied: 0.90≤Tab1/Tab2≤1.20. Furthermore, the following condition can be satisfied: 0.95≤Tab1/Tab2≤1.10.

When a total membrane thickness of the bokeh filter membrane at the maximum effective diameter is TKP, the following condition can be satisfied: 1250.0 nm<TKP. Therefore, the integrity of the membrane in the peripheral region can be maintained, and it is favorable for adjusting the amount of light entering the peripheral region and then achieving the effect of low transmittance. Furthermore, the following condition can be satisfied: 1260.0 nm TKP 5000.0 nm. Furthermore, the following condition can be satisfied: 1265.0 nm TKP 3000.0 nm. Furthermore, the following condition can be satisfied: 1270.0 nm TKP 2500.0 nm. Furthermore, the following condition can be satisfied: 1275.0 nm TKP 2000.0 nm. Furthermore, the following condition can be satisfied: 1280.0 nm TKP 1600.0 nm.

The gradient thickness absorbing membrane can include the first gradient thickness absorbing membrane and the second gradient thickness absorbing membrane, and the second gradient thickness absorbing membrane can be farther away from the substrate than the first gradient thickness absorbing membrane. When a refractive index of the first gradient thickness absorbing membrane is Nab1, and a refractive index of the second gradient thickness absorbing membrane is Nab2, the following condition can be satisfied: Nab1>Nab2. Therefore, by adjusting the refractive index of the gradient thickness absorbing membrane, it is favorable for reducing the generation of the reflected light.

The first high-and-low refraction membrane can include an adjacent membrane layer, the adjacent membrane layer is a layer of the first high-and-low refraction membrane closest to the first gradient thickness absorbing membrane. When the refractive index of the first gradient thickness absorbing membrane is Nab1, and a refractive index of the adjacent membrane layer is Narn, the following condition can be satisfied: 1.32≤Nab1/Narn≤2.00. Therefore, by maintaining the difference between the refractive indexes of the gradient thickness absorbing membrane and the adjacent membrane layer, it is favorable for reducing the reflected light between layers by the destructive interference. Furthermore, the following condition can be satisfied: 1.32≤Nab1/Narn≤1.90. Furthermore, the following condition can be satisfied: 1.34≤Nab1/Narn≤1.85. Furthermore, the following condition can be satisfied: 1.35≤Nab1/Narn≤1.80. Furthermore, the following condition can be satisfied: 1.36≤Nab1/Narn≤1.75. Furthermore, the following condition can be satisfied: 1.38≤Nab1/Narn≤1.70.

When a total membrane thickness of the first high-and-low refraction membrane is Tart the following condition can be satisfied: 105.0≤nm Tar1≤200.0 nm. Therefore, by controlling the first high-and-low refraction membrane to reach a specific thickness, the destructive interference is easy to be generated by the reflected light on the surface of the membranes that are spaced from each other, and it is favorable for enhancing the anti-reflection effect. Furthermore, the following condition can be satisfied: 110.0 nm≤Tar1≤180.0 nm. Furthermore, the following condition can be satisfied: 112.0 nm≤Tar1≤170.0 nm. Furthermore, the following condition can be satisfied: 115.0 nm≤Tar1≤160.0 nm. Furthermore, the following condition can be satisfied: 118.0 nm≤Tar1≤155.0 nm. Furthermore, the following condition can be satisfied: 120.0 nm≤Tar1≤150.0 nm.

When a total membrane thickness of the second high-and-low refraction membrane is Tar2, the following condition can be satisfied: 38.0 nm≤Tar2≤150.0 nm. Therefore, by controlling the second high-and-low refraction membrane to reach a specific thickness, the destructive interference is easy to be generated by the reflected light on the surface of the membranes that are spaced from each other, and it is favorable for enhancing the anti-reflection effect. Furthermore, the following condition can be satisfied: 38.5 nm≤Tar2≤130.0 nm. Furthermore, the following condition can be satisfied: 38.8 nm≤Tar2≤110.0 nm. Furthermore, the following condition can be satisfied: 39.0 nm≤Tar2≤90.0 nm. Furthermore, the following condition can be satisfied: 39.2 nm≤Tar2≤70.0 nm. Furthermore, the following condition can be satisfied: 39.5 nm≤Tar2≤50.0 nm.

When an average reflectance in a wavelength range of 400 nm-700 nm of the bokeh filter membrane at the center of the substrate is R4070-c, the following condition can be satisfied: 0%≤R4070-c≤3.00%. Therefore, the reflection effect of the wide-wavelength light at the center can be effectively controlled, and it is favorable for increasing the imaging quality at the center of the substrate. Furthermore, the following condition can be satisfied: 0%≤R4070-c≤2.00%. Furthermore, the following condition can be satisfied: 0%≤R4070-c≤1.50%. Furthermore, the following condition can be satisfied: 0%≤R4070-c≤1.00%. Furthermore, the following condition can be satisfied: 0%≤R4070-c≤0.50%. Furthermore, the following condition can be satisfied: 0.01≤R4070-c≤0.40%.

When an average reflectance in the wavelength range of 400 nm-700 nm of the bokeh filter membrane at a maximum effective diameter of the substrate is R4070-p, the following condition can be satisfied: 0%≤R4070-p≤3.00%. Therefore, the reflection effect of the wide-wavelength light at the maximum effective diameter can be effectively controlled, and it is favorable for reducing the generation of the stray light at the peripheral region of the substrate. Furthermore, the following condition can be satisfied: 0%≤R4070-p≤2.00%. Furthermore, the following condition can be satisfied: 0%≤R4070-p≤1.50%. Furthermore, the following condition can be satisfied: 0%≤R4070-p≤1.00%. Furthermore, the following condition can be satisfied: 0%≤R4070-p≤0.50%. Furthermore, the following condition can be satisfied: 0.01%≤R4070-p≤0.30%.

When a total membrane thickness of the gradient thickness absorbing membrane is 40 nm to 60 nm, and an average reflectance in a wavelength range of 400 nm-500 nm of the bokeh filter membrane is R4050-5, the following condition can be satisfied: 0%≤R4050-5≤0.70%. Therefore, by maintaining a low reflection effect of the gradient thickness absorbing membrane in a range of thinner thickness, it is favorable for reducing the generation of the reflected light with a short wavelength at the half of the maximum effective diameter of the substrate. Furthermore, the following condition can be satisfied: 0%≤R4050-5≤0.65%. Furthermore, the following condition can be satisfied: 0%≤R4050-5≤0.62%. Furthermore, the following condition can be satisfied: 0%≤R4050-5≤0.60%. Furthermore, the following condition can be satisfied: 0%≤R4050-5≤0.58%. Furthermore, the following condition can be satisfied: 0.01%≤R4050-5≤0.55%.

When the total membrane thickness of the gradient thickness absorbing membrane is 85 nm to 115 nm, and an average reflectance in a wavelength range of 450 nm-550 nm of the bokeh filter membrane is R4555-10, the following condition can be satisfied: 0%≤R4555-10≤0.82%. Therefore, by maintaining a low reflection effect of the gradient thickness absorbing membrane in a specific range of thickness, it is favorable for reducing the generation of the reflected light with a short wavelength at the peripheral region of the substrate. Furthermore, the following condition can be satisfied: 0%≤R4555-10≤0.75%. Furthermore, the following condition can be satisfied: 0%≤R4555-10≤0.72%. Furthermore, the following condition can be satisfied: 0%≤R4555-10≤0.65%. Furthermore, the following condition can be satisfied: 0%≤R4555-10≤0.62%. Furthermore, the following condition can be satisfied: 0.01%≤R4555-10≤0.60%.

When the total membrane thickness of the gradient thickness absorbing membrane is 180 nm to 220 nm, and an average reflectance in a wavelength range of 550 nm-700 nm of the bokeh filter membrane is R5570-20, the following condition can be satisfied: 0%≤R5570-20≤1.10%. Therefore, by maintaining a low reflection effect of the gradient thickness absorbing membrane in a range of thicker thickness, it is favorable for reducing the generation of the reflected light with a long wavelength at the peripheral region of the substrate. Furthermore, the following condition can be satisfied: 0%≤R5570-20≤1.05%. Furthermore, the following condition can be satisfied: 0.10%≤R5570-20≤1.05%. Furthermore, the following condition can be satisfied: 0.10%≤R5570-20≤1.00%. Furthermore, the following condition can be satisfied: 0.15%≤R5570-20≤0.98%. Furthermore, the following condition can be satisfied: 0.20%≤R5570-20≤0.98%.

When the total membrane thickness of the gradient thickness absorbing membrane is 450 nm to 550 nm, and an average reflectance in the wavelength range of 400 nm-700 nm of the bokeh filter membrane is R4070-50, the following condition can be satisfied: 0%≤R4070-50≤1.00%. Therefore, by maintaining a low reflection effect at the peripheral region of the substrate, it is favorable for reducing the generation of the reflected light at the peripheral region of the substrate. Furthermore, the following condition can be satisfied: 0%≤R4070-50≤0.90%. Furthermore, the following condition can be satisfied: 0%≤R4070-50≤0.75%. Furthermore, the following condition can be satisfied: 0%≤R4070-50≤0.60%. Furthermore, the following condition can be satisfied: 0%≤R4070-50≤0.50%. Furthermore, the following condition can be satisfied: 0.01%≤R4070-50≤0.35%.

When an average transmittance in the wavelength range of 400 nm-700 nm of the bokeh filter membrane at the maximum effective diameter of the substrate is T4070-p, the following condition can be satisfied: T4070-p≤3.00%. Therefore, by maintaining a lower transmittance at the maximum effective diameter of the substrate, it is favorable for removing the sharpness at the edge area and achieving the effect of soft edges of the image. Furthermore, the following condition can be satisfied: 0%≤T4070-p≤2.50%. Furthermore, the following condition can be satisfied: 0%≤T4070-p≤2.00%. Furthermore, the following condition can be satisfied: 0.10%≤T4070-p≤1.50%. Furthermore, the following condition can be satisfied: 0.30%≤T4070-p≤1.20%. Furthermore, the following condition can be satisfied: 0.50%≤T4070-p≤1.00%.

The average transmittance in the wavelength range of 400 nm-700 nm of the bokeh filter membrane at the maximum effective diameter of the substrate is T4070-p; the average transmittance in the wavelength range of 400 nm-700 nm of the bokeh filter membrane at the center of the substrate is T4070-c; when the total membrane thickness of the gradient thickness absorbing membrane is 40 nm to 60 nm, an average transmittance in the wavelength range of 400 nm-700 nm of the bokeh filter membrane is T4070-5; and when the total membrane thickness of the gradient thickness absorbing membrane is 180 nm to 220 nm, the average transmittance in the wavelength range of 400 nm-700 nm of the bokeh filter membrane is T4070-20. Accordingly, the following conditions can be satisfied: 100×(T4070-p/T4070-c)≤3.00; T4070-5/T4070-c≤1.20; and T4070-20/T4070-c≤0.80. Therefore, by the design that the transmittance gradually decreases from the center of the substrate to the peripheral region thereof, it is favorable for obtaining a more natural gradient dodging effect. Furthermore, the following conditions can be satisfied: 0≤100×(T4070-p/T4070-c)≤2.50; 0≤T4070-5/T4070-c≤1.10; and 0≤T4070-20/T4070-c≤0.70. Furthermore, the following conditions can be satisfied: 0≤100×(T4070-p/T4070-c)≤2.00; 0.10≤T4070-5/T4070-c≤1.05; and 0.01≤T4070-20/T4070-c≤0.65. Furthermore, the following conditions can be satisfied: 0.10≤100×(T4070-p/T4070-c)≤1.50; 0.20≤T4070-5/T4070-c≤1.00; and 0.10≤T4070-20/T4070-c≤0.60. Furthermore, the following conditions can be satisfied: 0.30≤100×(T4070-p/T4070-c)≤1.20; 0.30≤T4070-5/T4070-c≤0.95; and 0.20≤T4070-20/T4070-c≤0.55. Furthermore, the following conditions can be satisfied: 0.50≤100×(T4070-p/T4070-c)≤1.00; 0.40≤T4070-5/T4070-c≤0.90; and 0.30≤T4070-20/T4070-c≤0.50.

Each of the aforementioned features of the bokeh filter membrane of the present disclosure can be utilized in numerous combinations, so as to achieve the corresponding functionality.

According to another embodiment of the present disclosure, an imaging optical lens assembly includes the bokeh filter membrane of the aforementioned aspect, at least one optical lens element and at least one optical element. At least one surface of the at least one optical lens element and the at least one optical element includes the bokeh filter membrane.

According to the imaging optical lens assembly of the present disclosure, the imaging optical lens assembly can further include an aperture stop, wherein the optical element is located at an object side or an image side of the aperture stop, and at least one surface of the optical element includes the bokeh filter membrane. Therefore, by coating the bokeh filter membrane on the surface of the optical element and arranging the optical element in the imaging optical lens assembly, it is favorable for reducing the need for photography accessories.

According to the imaging optical lens assembly of the present disclosure, the at least one optical element includes a first optical element and a second optical element, wherein the first optical element is located at the object side of the aperture stop, the second optical element is located at the image side of the aperture stop, and at least one surface of the first optical element and at least one surface of the second optical element includes the bokeh filter membrane. Therefore, by the arrangement that the optical elements are disposed at both of the object side and the image side of the aperture stop and the surfaces thereof are coated with the bokeh filter membrane, it is favorable for achieving the effect of soft edges in all directions around the edges of the bokeh image.

According to the imaging optical lens assembly of the present disclosure, a distance along an optical axis between the surface including the bokeh filter membrane of the first optical element and the aperture stop is equal to a distance along the optical axis between the aperture stop and the surface including the bokeh filter membrane of the second optical element. Therefore, by the arrangement that the two surfaces including the bokeh filter membrane of the two optical elements are at the same distance from the aperture stop, it is favorable for maintaining all the peripheral lights of each of the fields to achieve a consistent dimming effect.

According to the imaging optical lens assembly of the present disclosure, the imaging optical lens assembly can further include the aperture stop, wherein at least one surface of the optical element includes the bokeh filter membrane, and the at least one surface is disposed on a position of the aperture stop. Therefore, by arranging the optical element with the surface including the bokeh filter membrane on the position of the aperture stop, it is favorable for achieving the best soft-edged effect for light at different incident angles.

According to the imaging optical lens assembly of the present disclosure, the imaging optical lens assembly can further include the aperture stop, wherein the optical lens element is located at an object side or an image side of the aperture stop, and at least one surface of the at least one optical lens element includes the bokeh filter membrane. Therefore, by coating the bokeh filter membrane on the surface of the optical lens element and arranging the optical lens element in the imaging optical lens assembly, it is favorable for reducing the total volume of the imaging optical lens assembly.

According to the imaging optical lens assembly of the present disclosure, the at least one optical lens element includes a first optical lens element and a second optical lens element, wherein the first optical lens element is located at the object side of the aperture stop, the second optical lens element is located at the image side of the aperture stop, and at least one surface of the first optical lens element and at least one surface of the second optical lens element include the bokeh filter membrane. Therefore, by the arrangement that the optical lens elements are disposed at both of the object side and the image side of the aperture stop and the surfaces thereof are coated with the bokeh filter membrane, it is favorable for achieving the effect of soft edges in all directions around the edges of the bokeh image.

According to the imaging optical lens assembly of the present disclosure, a distance along the optical axis between the surface including the bokeh filter membrane of the first optical lens element and the aperture stop is equal to a distance along the optical axis between the aperture stop and the surface including the bokeh filter membrane of the second optical lens element. Therefore, by the arrangement that the two surfaces including the bokeh filter membrane of the two optical lens elements are at the same distance from the aperture stop, it is favorable for maintaining all the peripheral lights of each of the fields to achieve a consistent dimming effect.

Each of the aforementioned features of the imaging optical lens assembly of the present disclosure can be utilized in numerous combinations, so as to achieve the corresponding functionality.

In the present disclosure, the substrate can be an optical lens element or an optical element, and the optical element can be a filter, a cover glass, a light path folding element, a diffraction element (such as a Fresnel lens), a light-blocking element, an annular spacer element, a barrel element, or a micro lens disposed on the image sensor. The filter can include a blue glass, an IR cut filter, a color filter, a bandpass filter, or a low-pass filter. The cover glass can include a protect mirror disposed on the most object side of the imaging optical lens assembly, a glass sheet disposed around the substrate of the image sensor, or a glass sheet used to protect the image sensor. The light path folding element can include a prism or a mirror. The light-blocking element, the annular spacer element and the barrel element can include a plate element made of a glass or a plastic material which is disposed on an optical effective diameter area, and at least one surface of the plate element includes an anti-reflection membrane.

In the present disclosure, a material of an absorbing membrane can be selected from at least one of the following materials, and the aforementioned materials includes: aluminum, gold, silver, chromium, nickel, copper, iron, zinc, tin, aluminum oxides, calcium oxides, chromium oxides, indium oxides, magnesium oxides, nickel oxides, lead oxides, tin oxides, titanium oxides, niobium oxides, tantalum oxides, zirconium oxides, molybdenum oxides, rubidium oxides, thorium oxides, sulfides, or phosphides. Or the aforementioned materials can be selected from at least one the following ions including manganese ion, chromium ion, vanadium ion, copper ion, cobalt ion, nickel ion, iron ion, tungsten ion, or molybdenum ion. All of the aforementioned materials can include a variety of oxidation states, wherein the first gradient thickness absorbing membrane can include the membrane layer made of tantalum oxides, and the second gradient thickness absorbing membrane can include the membrane layer made of titanium oxides.

In the present disclosure, the absorbing membrane can be any of the following three arrangements including the gradient thickness absorbing membrane, the gradient concentration absorbing membrane and the color-changing absorbing membrane. In the gradient thickness absorbing membrane, the membrane thickness of the gradient thickness absorbing membrane can be arranged with the center of the substrate as a center of a circle so as to produce differences in different positions in the form of concentric circles. Thus, by the arrangement that the membrane thickness of the gradient thickness absorbing membrane at the peripheral region of the substrate is greater than that at the center thereof, it is favorable for further designing the change of the membrane thickness of the gradient thickness absorbing membrane from the center of the substrate to the peripheral region thereof to be a linear function, a polynomial function, an exponential function, or a logarithmic function. Or the substrate can be divided into a plurality of areas from the center to the peripheral region thereof, and the change of the membrane thickness in each of the areas can be any one of the aforementioned functions, so that a transmittance can gradually decrease from the center of the substrate to the peripheral region thereof. In the gradient concentration absorbing membrane, the membrane thickness of the gradient concentration absorbing membrane at the center of the substrate and at the peripheral region thereof can be relatively uniform. The gradient concentration absorbing membrane includes at least one of the aforementioned materials of the absorbing membrane, the content ratio of the material of the absorbing membrane gradually increases from the center of the substrate to the peripheral region thereof, and the material of the absorbing membrane is distributed evenly throughout the substrate. The change of the content ratio of the material in the gradient concentration absorbing membrane can be further designed from the center of the substrate to the peripheral region thereof to be a linear function, a polynomial function, an exponential function, or a logarithmic function. Or the substrate can be divided into a plurality of areas from the center to the peripheral region thereof, and the change of the content ratio in each of the areas can be any one of the aforementioned functions, so that a transmittance can gradually decrease from the center of the substrate to the peripheral region thereof. In the color-changing absorbing membrane, the color-changing absorbing membrane can be an electrochromic composite membrane including any one of the aforementioned materials of the absorbing membrane or the organic compounds. The color-changing absorbing membrane can include an inorganic transition metal oxide including tungsten trioxide (WO₃), nickel oxide (NiO) or titanium dioxide (TiO₂). The color-changing absorbing membrane can make the material thereof undergo a reversible electrochemical reaction by an external electric field. The ions are embedded or extracted from the crystal structure of the material by the external electric field, so that the color-changing absorbing membrane will change the color thereof and absorb the visible light and the infrared light, and the transmittance of the bokeh filter membrane can be changed.

In the present disclosure, the range of the total membrane thickness of the gradient thickness absorbing membrane as well as the average reflectance and the average transmittance in specific wavelength ranges can be changed according to the design needs, and it is not limited to the conditional conditions.

In the imaging optical lens assembly of the present disclosure, the object side is the side where the light is incident on the imaging optical lens assembly, and the image side is the side where the light is imaged to the image surface. The optical axis is an axis of an axisymmetric optical system including at least two rotationally symmetric reflective surfaces or a common axis of the two refractive surfaces. The center represents a relatively narrow region near the optical axis and including the optical axis. The peripheral region represents a non-center area within the range of the optical effective diameter.

In the present disclosure, the bokeh filter membrane is disposed at a position of the imaging optical lens assembly. The imaging optical lens assembly can include a first bokeh filter membrane, a second bokeh filter membrane and an aperture stop. The first bokeh filter membrane and the second bokeh filter membrane are respectively arranged on different substrates, wherein the first bokeh filter membrane is disposed on an object side of the aperture stop, and the second bokeh filter membrane is disposed on an image side of the aperture stop. When a distance along the optical axis between the aperture stop and the first bokeh filter membrane is SDE1, and a distance along the optical axis between the aperture stop and the second bokeh filter membrane is SDE2, the following condition can be satisfied: 0.5<|SDE1/SDE2|<2.0. Further, based on the difference in the distances between the first bokeh filter membrane and the second bokeh filter membrane from the aperture stop and the change of the curvature of the substrate from the center to the maximum effective diameter as well as the difference in the angles of incident light, the change of the membrane thickness from the center to the peripheral region of both the first bokeh filter membrane and the second bokeh filter membrane can be respectively adjusted.

In the present disclosure, the relative positional relationship of each of the membrane layers is a relative relationship along the direction perpendicular to the tangent line on the surface of the substrate under the same position.

In the present disclosure, the change of the transmittance from the center of the substrate to the peripheral region can be Gaussian distribution and can be represented as the following formula: Tm=exp(−αx²), wherein Tm is a transmittance, a is a constant, and x is a vertical distance between a point on the curve of the surface of the substrate and the optical axis.

In the present disclosure, both the refractive index and the extinction coefficient are based on the wavelength of 555 nm as the benchmark.

In the present disclosure, the reflectance is measured with a single lens, and the reflectance is based on the data at an incident angle of 0 degrees as a benchmark.

In the present disclosure, the main material represents that the material accounts for at least 50% of the overall weight.

In the present disclosure, the surface pore-making process can effectively enhance the distribution of pores on the surface, and thus the gap between pores on the surface can be increased so as to present a sponge-like structure or change the porosity, density, etc. The effects of the pore-making process can also change along with the increase of the depth, for example, the outer side exposed to air has a larger pore structure, while the inner side being deeper has a relatively smaller pore structure. The pores are composed of spaces between the irregular nanofibers, which have the effect of allowing air to remain or communicate between the pores. The outer side and the inner side of the bokeh filter membrane refer to that in the cross-sectional view and schematic view thereof, the outer side is the side in contact with the air, and the inner side is the side closer to the substrate. It is obvious that the pores/notches on the outer side are relatively larger than that on the inner side, and it can also be explained that in the same plane, the distribution density of irregular dendritic structures on the outer side under is relatively sparse, while the distribution density of irregular dendritic structures on the inner side is relatively tight. The manufacturing process thereof can be the plasma etching, the chemical reaction etching, the time-controlled crystal particle size technology or the high-temperature solution treatment, such as immersing in alcohol or water with a temperature above 50 degrees.

In the present disclosure, all of the outer side to the inner side of the gradient refraction membrane can be processed by surface pore-making process, so that a design in which the refractive index changes gradually from the outer side to the inner side can be formed, and it is favorable for reducing the reflected light caused by the excessive difference in the refractive index between the membrane layers. The measuring method of the membrane thickness of the gradient refraction membrane can select at least the first three highest vertices and measure the height of the vertices in the direction perpendicular to the tangent of the surface of the inner membrane layer in the cross-sectional view, and then calculate an average value thereof. The main material of the gradient refraction membrane can be metal oxides, aluminum oxide, aluminum nitride (AlN), aluminum hydroxide (Al(OH)₃), or aluminum-containing mixtures.

In the present disclosure, the high-and-low refraction membrane can include a high refraction membrane and a low refraction membrane. A refractive index of the material of the high refraction membrane is larger than 2.0, and a refractive index of the material of the low refraction membrane is smaller than 1.8. The coating material of the high-and-low refraction membrane can be (values in parentheses are refractive indices at wavelength=587.6 nm): MgF₂ (1.3777), SiO₂ (1.4585), Al₂O₃ (1.7682), HfO₂ (1.8935), ZnO (1.9269), Sc₂O₃ (1.9872), AlN (2.0294), Si₃N₄ (2.0381), Ta₂O₅ (2.1306), ZrO₂ (2.1588), ZnS (2.2719), Nb₂O₅ (2.3403), TiO₂ (2.6142), or TiN (3.1307), and the refractive index is based on the wavelength of 587.6 nm and only for this paragraph.

In the present disclosure, the material of the first layer close to the surface of the substrate can be TiO₂, AlN, Al₂O₃, Al(OH)₃ or aluminum-containing mixtures, can be zinc oxide or magnesium oxide, or can be a mixed material of at least one of the aforementioned aluminum oxide, zinc oxide, magnesium oxide and other metal oxides. The aforementioned materials have the characteristics of a dense structure and can strengthen the adhesion between the material and the surface of the substrate so as to avoid the peeling off of the membrane. Thus, the effect of protecting the surface of the substrate during the coating process can be achieved, and it is favorable for effectively enhancing the environmental weather resistance of the substrate.

In the present disclosure, the anti-reflection membrane is based on the principle of constructive interference. In the surface coating on a common lens element, the surface of the plastic substrate can be coated with a single-layer membrane or a multiple-layer membrane by physical vapor deposition (PVD), such as evaporation or sputtering, or chemical vapor deposition (CVD), such as ultra-high vacuum chemical vapor deposition, microwave plasma-assisted chemical vapor deposition, plasma-enhanced chemical vapor deposition or atomic layer deposition (ALD), etc. The preparation of coating membranes has the best of the value by the ALD, and a balance between the cost and the quality can be obtained. Further, the coating membranes can be formed on the lens material with the most appropriate refractive index, so that the best anti-reflection effect can be achieved.

In the present disclosure, the full field is the range from the central field (0 Field) to the maximum image high field (1.0 Field), and the full field covers the optical effective area of the surface of the lens element.

In the present disclosure, the tangent slope of the surface of the lens element is calculated with the optical axis as the horizontal direction, and the tangent slope is infinite at the paraxial region (Infinity, INF, ∞).

In the compensating lens element of the present disclosure, in particular, the surface change error of the plastic lens element will be excessively caused by the thickness and the high temperature, and when the number of layer is more, the effect of the temperature on surface accuracy is more obvious. Thus, by the lens compensating technology, the temperature effect problem during the coating process on the surface of the plastic material can be effectively solved, so that it is favorable for maintaining the integrity of the coatings and the high precision of the plastic lens element, and it is a key technology for achieving the imaging optical lens assembly with high quality.

In the present disclosure, the lens compensating technology can be the moldflow analysis method, the curve fitting method or the wavefront error method, but the present disclosure is not limited thereto. The moldflow analysis method is to find the three-dimensional contour nodes of the lens surface shrinking in the Z-axis through mold flow analysis, and then the three-dimensional contour nodes are converted into an aspherical curve so as to compare with the original curve to find the difference there between. At the same time, the material shrinkage rate and the surface deformation trend are considered so as to calculate and obtain the compensation value. The curve fitting method is to measure the surface contour error of the element, then the curve fitting is performed based on a function, and then an optimization algorithm method is used to approximate the fitted curve to the measurement point so as to obtain the compensation value. The function can be exponential or polynomial, and the algorithm method can be Gauss Newton method, the simplex algorithm method or the steepest descent method, etc. The wavefront error method is to measure the wavefront error (imaging error) data by the interferometer, and the wavefront error generated by the manufacturing and the assembly is comprehensively analyzed by the original design value of the wavefront error and then optimized by an optical software so as to obtain the compensation value.

In the present disclosure, the imaging optical lens assembly can be designed for a miniature lens assembly and also can be applied to the electronic devices, such as mobile devices, digital tablets, 3D (three-dimensional) image capturing applications, digital cameras, smart TVs, surveillance systems, motion sensing input devices, driving recording systems, rearview camera systems, wearable devices, unmanned aerial vehicles, etc.

According to one aspect of the present disclosure, an imaging apparatus includes the imaging optical lens assembly according to the aforementioned aspect and an image sensor. The image sensor is disposed on an image surface of the imaging optical lens assembly.

The imaging apparatus is a camera module, and the imaging apparatus includes the imaging optical lens assembly, a driving apparatus and the image sensor, wherein the camera module includes the imaging optical lens assembly of the present disclosure and a lens barrel for carrying the imaging optical lens assembly. The imaging apparatus can focus light from an imaged object via the imaging optical lens assembly, perform image focusing by the driving apparatus, and generate an image on the image sensor, so that the imaging information can be transmitted.

The imaging apparatus can be a wide angle imaging apparatus, an ultra-wide angle imaging apparatus, a telephoto imaging apparatus imaging apparatus (which can include a light path folding element), or a TOF module (Time-Of-Flight), but it is not limited thereof. Further, the connecting relationships between the imaging apparatus and other elements can be adaptively adjusted according to the type of the imaging apparatuses, which will not be shown and detailed descripted again.

The imaging apparatus can include an image sensor with superior photosensitivity and low noise (such as CMOS, CCD), and the image sensor is disposed on the image surface of the imaging optical lens assembly. Thus, it is favorable for truly presenting the good imaging quality of the imaging optical lens assembly. Further, the imaging apparatus can further include an image stabilization module, which can be a kinetic energy sensor, such as an accelerometer, a gyro sensor, and a Hall Effect sensor, but it is not limited thereto. Therefore, the variation of different axial directions of the imaging optical lens assembly can be adjusted so as to compensate the blurry image generated by motion at the moment of exposure, and it is further favorable for enhancing the image quality while photographing in motion and low light situation. Furthermore, advanced image compensation functions, such as optical image stabilizations (OIS) and electronic image stabilizations (EIS) etc., can be provided.

The imaging apparatus can be relative to a non-circular opening on the outside of an electronic device for capturing the image.

The driving apparatus can be an auto-focus module, and it can be driven by driving systems, such as voice coil motors (VCM), micro electro-mechanical systems (MEMS), piezoelectric systems, and shape memory alloys, etc. The imaging optical lens assembly can obtain a favorable imaging position by the driving apparatus so as to capture clear images when the imaged object is disposed at different object distances.

According to another aspect of the present disclosure, an electronic device includes the imaging apparatus according to the aforementioned aspect. Therefore, the image quality can be increased. Further, the electronic device can further include a control unit, a display, a storage unit, a random-access memory unit (RAM) or a combination thereof.

According to another aspect of the present disclosure, an electronic device, which is a mobile device, includes the imaging apparatus according to the aforementioned aspect.

The electronic device can be a smart phone and includes the imaging apparatus, a flash module, a focusing assisting module, an image signal processor (ISP), a user interface and an image software processor, wherein the imaging apparatus can be a front camera or a back camera. When the user captures images of an imaged object via the user interface, the electronic device focuses and generates an image via the imaging apparatus, while compensating for low illumination via the flash module. Then, the electronic device quickly focuses on the imaged object according to its object distance information provided by the focusing assisting module and optimizes the image via the image signal processor and the image software processor, so that the image quality can be further enhanced. Further, the focusing assisting module can adopt conventional infrared or laser for obtaining quick focusing, and the user interface can utilize a touch screen or a physical button for capturing and processing the image with various functions of the image processing software.

According to the above description of the present disclosure, the following specific embodiments along with the figures are provided for further explanation.

### Comparative Example 1

In Comparative example 1, a bokeh filter membrane is disposed on a surface of a substrate. The bokeh filter membrane includes a gradient thickness absorbing membrane and an anti-reflection membrane. The gradient thickness absorbing membrane includes a first gradient thickness absorbing membrane and a second gradient thickness absorbing membrane, and the anti-reflection membrane includes a high-and-low refraction membrane and a gradient refraction membrane. The high-and-low refraction membrane includes a first high-and-low refraction membrane and a second high-and-low refraction membrane. The first high-and-low refraction membrane includes an adjacent membrane layer, and the adjacent membrane layer is a layer of the first high-and-low refraction membrane closest to the first gradient thickness absorbing membrane.

The details of each layer of the bokeh filter membrane of Comparative example 1 are shown in Table 1 A.

TABLE 1A

| Layer | | Refractive | Physical | Extinction |
|---|---|---|---|---|
| Sequence | Material | index | thickness (nm) | coefficient |
| Substrate | — | 1.50 | — | 0 |
| 1 | — | 2.21 | 6.2 | 0 |
| 2 | — | 1.66 | 51.4 | 0 |
| 3 | — | 2.21 | 22.5 | 0 |
| 4 | — | 1.66 | 17.9 | 0 |
| 5 | — | 2.12 | 0~500 | 0.19 |
| 6 | — | 2.32 | 0~500 | 0.20 |
| 7 | — | 1.66 | 15.0 | 0 |
| 8 | — | 2.21 | 21.4 | 0 |
| 9 | — | 1.39 | 96.7 | 0 |

Table 1B shows the parameters of each layer of the bokeh filter membrane of Comparative example 1, wherein TNG is a membrane thickness of the gradient refraction membrane, Nab1 is a refractive index of the first gradient thickness absorbing membrane, Nab2 is a refractive index of the second gradient thickness absorbing membrane, Narn is a refractive index of the adjacent membrane layer, Tab1 is a membrane thickness of the first gradient thickness absorbing membrane at a maximum effective diameter, Tab2 is a membrane thickness of the second gradient thickness absorbing membrane at the maximum effective diameter, Tar1 is a total membrane thickness of the first high-and-low refraction membrane, Tar2 is a total membrane thickness of the second high-and-low refraction membrane, and TKP is a total membrane thickness of the bokeh filter membrane at the maximum effective diameter.

TABLE 1B

| | | | |
|---|---|---|---|
| TNG (nm) | 96.7 | Tab1/Tab2 | 1.0 |
| Nab1 | 2.12 | Tar1 (nm) | 98.0 |
| Nab2 | 2.32 | Tar2 (nm) | 36.4 |
| Nab1/Narn | 1.28 | TKP (nm) | 1231.1 |

Table 1C shows the parameters of the bokeh filter membrane of Comparative example 1. R4070-c is an average reflectance in a wavelength range of 400 nm-700 nm of the bokeh filter membrane at the center of the substrate. R4050-5 is, when a total membrane thickness of the gradient thickness absorbing membrane is 40 nm to 60 nm, an average reflectance in a wavelength range of 400 nm-500 nm of the bokeh filter membrane. R4555-10 is, when the total membrane thickness of the gradient thickness absorbing membrane is 85 nm to 115 nm, an average reflectance in a wavelength range of 450 nm-550 nm of the bokeh filter membrane. R5570-20 is, when the total membrane thickness of the gradient thickness absorbing membrane is 180 nm to 220 nm, an average reflectance in a wavelength range of 550 nm-700 nm of the bokeh filter membrane. R4070-50 is, when the total membrane thickness of the gradient thickness absorbing membrane is 450 nm to 550 nm, an average reflectance in the wavelength range of 400 nm-700 nm of the bokeh filter membrane. R4070-p is an average transmittance in the wavelength range of 400 nm-700 nm of the bokeh filter membrane at the maximum effective diameter of the substrate.

TABLE 1C

| | | | |
|---|---|---|---|
| R4070-c | 0.46 | R5570-20 | 0.66 |
| R4050-5 | 0.89 | R4070-50 | — |
| R4555-10 | 0.88 | R4070-p | 0.36 |

If the definitions of parameters shown in tables of the following examples are the same as those shown in Table 1A to Table 1C, those will not be described again.

### Example 1

A bokeh filter membrane of Example 1 is disposed on a surface of a substrate. The bokeh filter membrane includes a gradient thickness absorbing membrane and an anti-reflection membrane. The gradient thickness absorbing membrane includes a first gradient thickness absorbing membrane and a second gradient thickness absorbing membrane, and the anti-reflection membrane includes a high-and-low refraction membrane and a gradient refraction membrane. The high-and-low refraction membrane includes a first high-and-low refraction membrane and a second high-and-low refraction membrane. The first high-and-low refraction membrane includes an adjacent membrane layer, and the adjacent membrane layer is a layer of the first high-and-low refraction membrane closest to the first gradient thickness absorbing membrane.

The details of each layer of the bokeh filter membrane of Example 1 are shown in Table 2A, wherein “ab1” represents the layer is made of tantalum oxides, and “ab2” represents the layer is made of titanium oxides.

TABLE 2A

| Layer | | Refractive | Physical | Extinction |
|---|---|---|---|---|
| Sequence | Material | index | thickness (nm) | coefficient |
| Substrate | Glass | 1.52 | — | 0 |
| 1 | ZrO₂ | 2.07 | 19.0 | 4.0E−05 |
| 2 | SiO₂ | 1.46 | 25.0 | 0 |
| 3 | ZrO₂ | 2.07 | 80.0 | 4.0E−05 |
| 4 | SiO₂ | 1.46 | 5.0 | 0 |
| 5 | ab1 | 2.34 | 0~500 | 0.21 |
| 6 | ab2 | 2.11 | 0~500 | 0.17 |
| 7 | SiO₂ | 1.46 | 20.0 | 0 |
| 8 | ZrO₂ | 2.07 | 23.0 | 4.0E−05 |
| 9 | Al₂O₃ | 1.22 | 200.0 | 0 |

Table 2B shows the values of TNG, Nab1, Nab2, Nab1/Narn, Tab1/Tab2, Tar1, Tar2 and TKP of Example 1.

TABLE 2B

| | | | |
|---|---|---|---|
| TNG (nm) | 200.0 | Tab1/Tab2 | 1.0 |
| Nab1 | 2.34 | Tar1 (nm) | 129.0 |
| Nab2 | 2.11 | Tar2 (nm) | 43.0 |
| Nab1/Narn | 1.60 | TKP (nm) | 1372.0 |

Table 2C shows the values of R4070-c, R4050-5, R4555-10, R5570-20, R4070-50 and R4070-p of the bokeh filter membrane of Example 1.

TABLE 2C

| | | | |
|---|---|---|---|
| R4070-c | 0.21 | R5570-20 | 0.30 |
| R4050-5 | 0.48 | R4070-50 | 0.20 |
| R4555-10 | 0.30 | R4070-p | 0.18 |

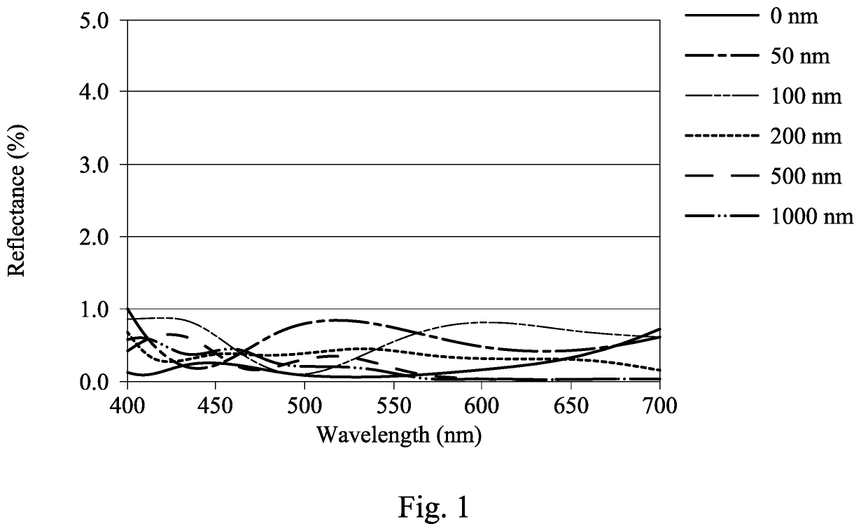

Reference is made by FIG. 1 and Table 2D. FIG. 1 is a relationship diagram between the reflectance and the wavelengths of a bokeh filter membrane including a gradient thickness absorbing membrane with different total membrane thicknesses according to Example 1, and Table 2D shows the values of reflectance of the bokeh filter membrane of Example 1 in the wavelength range of 400 nm to 700 nm in which the gradient thickness absorbing membrane thereof is with different total membrane thicknesses.

TABLE 2D

| | Total membrane thickness of gradient | | | | | |
|---|---|---|---|---|---|---|
| | thickness absorbing membrane (nm) | | | | | |
| Wavelength | 0 | 50 | 100 | 200 | 500 | 1000 |
| (nm) | Reflectance (%) | | | | | |
| 400 | 0.12 | 0.98 | 0.88 | 0.67 | 0.42 | 0.57 |
| 405 | 0.09 | 0.81 | 0.87 | 0.49 | 0.49 | 0.60 |
| 410 | 0.10 | 0.65 | 0.87 | 0.38 | 0.56 | 0.60 |
| 415 | 0.12 | 0.50 | 0.88 | 0.31 | 0.62 | 0.55 |
| 420 | 0.16 | 0.37 | 0.89 | 0.29 | 0.65 | 0.49 |
| 425 | 0.19 | 0.28 | 0.88 | 0.29 | 0.66 | 0.43 |
| 430 | 0.22 | 0.21 | 0.86 | 0.31 | 0.64 | 0.39 |
| 435 | 0.24 | 0.18 | 0.82 | 0.33 | 0.60 | 0.38 |
| 440 | 0.25 | 0.17 | 0.76 | 0.36 | 0.54 | 0.39 |
| 445 | 0.26 | 0.19 | 0.70 | 0.37 | 0.47 | 0.41 |
| 450 | 0.26 | 0.22 | 0.62 | 0.38 | 0.38 | 0.43 |
| 455 | 0.25 | 0.28 | 0.54 | 0.38 | 0.30 | 0.44 |
| 460 | 0.23 | 0.34 | 0.46 | 0.37 | 0.24 | 0.43 |
| 465 | 0.22 | 0.41 | 0.37 | 0.37 | 0.19 | 0.41 |
| 470 | 0.20 | 0.48 | 0.30 | 0.36 | 0.16 | 0.37 |
| 475 | 0.18 | 0.55 | 0.23 | 0.36 | 0.15 | 0.33 |
| 480 | 0.16 | 0.61 | 0.18 | 0.36 | 0.17 | 0.29 |
| 485 | 0.14 | 0.67 | 0.14 | 0.36 | 0.21 | 0.25 |
| 490 | 0.12 | 0.72 | 0.11 | 0.37 | 0.25 | 0.22 |
| 495 | 0.10 | 0.77 | 0.10 | 0.38 | 0.29 | 0.20 |
| 500 | 0.09 | 0.79 | 0.10 | 0.40 | 0.32 | 0.19 |
| 505 | 0.07 | 0.82 | 0.12 | 0.41 | 0.34 | 0.19 |
| 510 | 0.07 | 0.84 | 0.14 | 0.42 | 0.36 | 0.20 |
| 515 | 0.06 | 0.84 | 0.18 | 0.44 | 0.36 | 0.21 |
| 520 | 0.06 | 0.84 | 0.22 | 0.45 | 0.35 | 0.21 |
| 525 | 0.05 | 0.84 | 0.27 | 0.45 | 0.33 | 0.20 |
| 530 | 0.05 | 0.82 | 0.33 | 0.45 | 0.30 | 0.19 |
| 535 | 0.06 | 0.81 | 0.38 | 0.45 | 0.27 | 0.17 |
| 540 | 0.06 | 0.78 | 0.44 | 0.44 | 0.23 | 0.14 |
| 545 | 0.06 | 0.76 | 0.49 | 0.44 | 0.20 | 0.12 |
| 550 | 0.07 | 0.73 | 0.55 | 0.42 | 0.17 | 0.09 |
| 555 | 0.08 | 0.70 | 0.60 | 0.41 | 0.14 | 0.07 |
| 560 | 0.08 | 0.67 | 0.64 | 0.39 | 0.12 | 0.05 |
| 565 | 0.09 | 0.65 | 0.68 | 0.38 | 0.10 | 0.04 |
| 570 | 0.10 | 0.62 | 0.72 | 0.37 | 0.09 | 0.03 |
| 575 | 0.11 | 0.59 | 0.74 | 0.35 | 0.07 | 0.02 |
| 580 | 0.12 | 0.57 | 0.77 | 0.34 | 0.06 | 0.01 |
| 585 | 0.13 | 0.54 | 0.79 | 0.33 | 0.05 | 0.01 |
| 590 | 0.14 | 0.52 | 0.80 | 0.32 | 0.04 | 0.01 |
| 595 | 0.15 | 0.50 | 0.81 | 0.32 | 0.04 | 0.01 |
| 600 | 0.16 | 0.48 | 0.81 | 0.31 | 0.03 | 0.01 |
| 605 | 0.17 | 0.47 | 0.81 | 0.31 | 0.03 | 0.01 |
| 610 | 0.18 | 0.45 | 0.80 | 0.31 | 0.03 | 0.01 |
| 615 | 0.19 | 0.44 | 0.80 | 0.31 | 0.02 | 0.01 |
| 620 | 0.21 | 0.44 | 0.79 | 0.31 | 0.02 | 0.01 |
| 625 | 0.22 | 0.43 | 0.77 | 0.31 | 0.02 | 0.01 |
| 630 | 0.24 | 0.43 | 0.76 | 0.31 | 0.02 | 0.02 |
| 635 | 0.26 | 0.42 | 0.74 | 0.30 | 0.02 | 0.02 |
| 640 | 0.28 | 0.43 | 0.73 | 0.30 | 0.02 | 0.02 |
| 645 | 0.30 | 0.43 | 0.71 | 0.30 | 0.02 | 0.02 |
| 650 | 0.33 | 0.43 | 0.70 | 0.29 | 0.01 | 0.02 |
| 655 | 0.35 | 0.44 | 0.68 | 0.29 | 0.01 | 0.02 |
| 660 | 0.38 | 0.45 | 0.67 | 0.28 | 0.01 | 0.03 |
| 665 | 0.41 | 0.47 | 0.66 | 0.27 | 0.01 | 0.03 |
| 670 | 0.45 | 0.48 | 0.64 | 0.26 | 0.01 | 0.03 |
| 675 | 0.49 | 0.50 | 0.63 | 0.24 | 0.00 | 0.04 |
| 680 | 0.53 | 0.52 | 0.63 | 0.23 | 0.00 | 0.04 |
| 685 | 0.57 | 0.54 | 0.62 | 0.21 | 0.00 | 0.04 |
| 690 | 0.62 | 0.57 | 0.61 | 0.19 | 0.00 | 0.05 |
| 695 | 0.67 | 0.60 | 0.61 | 0.18 | 0.00 | 0.05 |
| 700 | 0.72 | 0.63 | 0.61 | 0.16 | 0.00 | 0.06 |

Table 2E shows the values of the bokeh filter membrane of Example 1, wherein T4070-p is an average transmittance in the wavelength range of 400 nm-700 nm of the bokeh filter membrane at the maximum effective diameter of the substrate, T4070-c is an average transmittance in the wavelength range of 400 nm-700 nm of the bokeh filter membrane at the center of the substrate, T4070-5 is an average transmittance in the wavelength range of 400 nm-700 nm of the bokeh filter membrane when the total membrane thickness of the gradient thickness absorbing membrane is 40 nm to 60 nm, and T4070-20 is an average transmittance in the wavelength range of 400 nm-700 nm of the bokeh filter membrane when the total membrane thickness of the gradient thickness absorbing membrane is 180 nm to 220 nm.

TABLE 2E

| | |
|---|---|
| T4070-p | 0.87 |
| 100 × (T4070-p/T4070-c) | 0.88 |
| T4070-5/T4070-c | 0.79 |
| T4070-20/T4070-c | 0.38 |

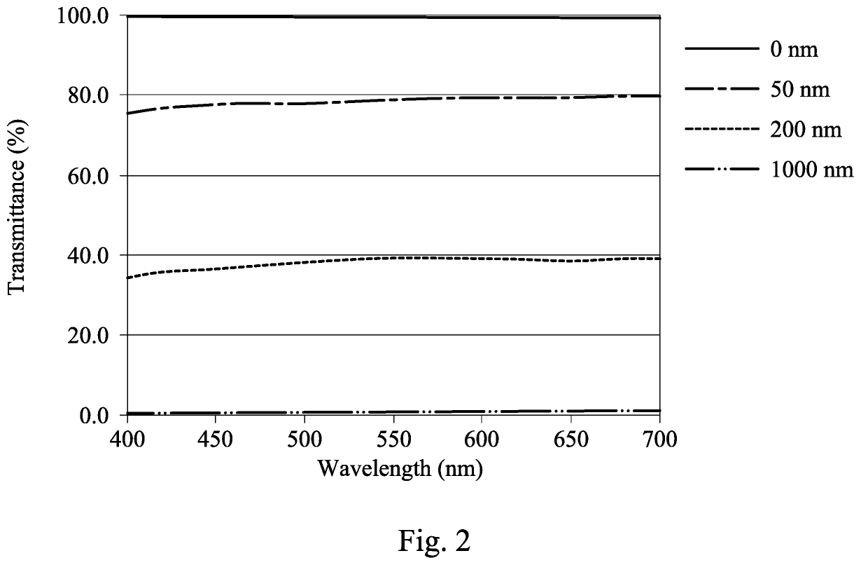

Reference is made to FIG. 2 and Table 2F. FIG. 2 is a relationship diagram between the transmittance and the wavelengths of the bokeh filter membrane including the gradient thickness absorbing membrane with different total membrane thicknesses according to Example 1, and Table 2F shows the values of transmittance of the bokeh filter membrane of Example 1 in the wavelength range of 400 nm to 700 nm in which the gradient thickness absorbing membrane thereof is with different total membrane thicknesses.

TABLE 2F

Total membrane thickness of gradient
thickness absorbing membrane (nm)

| | | | |
|---|---|---|---|
| 0 | 50 | 200 | 1000 |

| | |
|---|---|
| Wavelength (nm) | Transmittance (%) |

| | | | | |
|---|---|---|---|---|
| 400 | 99.72 | 75.22 | 34.59 | 0.53 |
| 405 | 99.76 | 75.67 | 34.96 | 0.55 |
| 410 | 99.76 | 76.07 | 35.26 | 0.56 |
| 415 | 99.75 | 76.43 | 35.49 | 0.58 |
| 420 | 99.73 | 76.73 | 35.68 | 0.59 |
| 425 | 99.70 | 76.97 | 35.83 | 0.60 |
| 430 | 99.67 | 77.17 | 35.96 | 0.61 |
| 435 | 99.64 | 77.32 | 36.07 | 0.63 |
| 440 | 99.62 | 77.44 | 36.19 | 0.64 |
| 445 | 99.62 | 77.53 | 36.32 | 0.65 |
| 450 | 99.61 | 77.59 | 36.45 | 0.66 |
| 455 | 99.63 | 77.65 | 36.60 | 0.67 |
| 460 | 99.66 | 77.70 | 36.77 | 0.69 |
| 465 | 99.70 | 77.75 | 36.95 | 0.70 |
| 470 | 99.72 | 77.78 | 37.13 | 0.72 |
| 475 | 99.75 | 77.81 | 37.31 | 0.74 |
| 480 | 99.78 | 77.84 | 37.49 | 0.76 |
| 485 | 99.81 | 77.88 | 37.67 | 0.78 |
| 490 | 99.83 | 77.92 | 37.84 | 0.80 |
| 495 | 99.86 | 77.97 | 38.01 | 0.82 |
| 500 | 99.89 | 78.04 | 38.18 | 0.84 |
| 505 | 99.91 | 78.10 | 38.34 | 0.86 |
| 510 | 99.92 | 78.16 | 38.49 | 0.88 |
| 515 | 99.93 | 78.23 | 38.63 | 0.90 |
| 520 | 99.94 | 78.31 | 38.75 | 0.92 |
| 525 | 99.94 | 78.39 | 38.87 | 0.94 |
| 530 | 99.94 | 78.48 | 38.97 | 0.95 |
| 535 | 99.94 | 78.56 | 39.06 | 0.97 |
| 540 | 99.94 | 78.65 | 39.14 | 0.99 |
| 545 | 99.94 | 78.73 | 39.20 | 1.00 |
| 550 | 99.93 | 78.81 | 39.25 | 1.01 |
| 555 | 99.92 | 78.89 | 39.28 | 1.02 |
| 560 | 99.92 | 78.96 | 39.30 | 1.03 |
| 565 | 99.91 | 79.03 | 39.31 | 1.04 |
| 570 | 99.90 | 79.10 | 39.31 | 1.05 |
| 575 | 99.89 | 79.15 | 39.29 | 1.05 |
| 580 | 99.88 | 79.21 | 39.27 | 1.05 |
| 585 | 99.87 | 79.25 | 39.23 | 1.05 |
| 590 | 99.86 | 79.29 | 39.19 | 1.05 |
| 595 | 99.85 | 79.33 | 39.15 | 1.04 |
| 600 | 99.84 | 79.36 | 39.10 | 1.04 |
| 605 | 99.82 | 79.39 | 39.05 | 1.03 |
| 610 | 99.81 | 79.41 | 39.01 | 1.02 |
| 615 | 99.79 | 79.43 | 38.97 | 1.02 |
| 620 | 99.78 | 79.45 | 38.93 | 1.01 |
| 625 | 99.76 | 79.47 | 38.90 | 1.00 |
| 630 | 99.74 | 79.49 | 38.87 | 0.99 |
| 635 | 99.72 | 79.51 | 38.85 | 0.99 |
| 640 | 99.69 | 79.52 | 38.84 | 0.98 |
| 645 | 99.67 | 79.54 | 38.84 | 0.97 |
| 650 | 99.64 | 79.56 | 38.84 | 0.97 |
| 655 | 99.61 | 79.57 | 38.85 | 0.96 |
| 660 | 99.58 | 79.59 | 38.88 | 0.95 |
| 665 | 99.54 | 79.61 | 38.91 | 0.95 |
| 670 | 99.51 | 79.63 | 38.94 | 0.95 |
| 675 | 99.47 | 79.64 | 38.99 | 0.94 |
| 680 | 99.43 | 79.67 | 39.05 | 0.94 |
| 685 | 99.40 | 79.70 | 39.11 | 0.94 |
| 690 | 99.36 | 79.72 | 39.18 | 0.93 |
| 695 | 99.31 | 79.75 | 39.26 | 0.93 |
| 700 | 99.27 | 79.77 | 39.34 | 0.93 |

### Example 2

A bokeh filter membrane of Example 2 is disposed on a surface of a substrate. The bokeh filter membrane includes a gradient thickness absorbing membrane and an anti-reflection membrane. The gradient thickness absorbing membrane includes a first gradient thickness absorbing membrane and a second gradient thickness absorbing membrane, and the anti-reflection membrane includes a high-and-low refraction membrane and a gradient refraction membrane. The high-and-low refraction membrane includes a first high-and-low refraction membrane and a second high-and-low refraction membrane. The first high-and-low refraction membrane includes an adjacent membrane layer, and the adjacent membrane layer is a layer of the first high-and-low refraction membrane closest to the first gradient thickness absorbing membrane.

The details of each layer of the bokeh filter membrane of Example 2 are shown in Table 3A, wherein “ab1” represents the layer is made of tantalum oxides, and “ab2” represents the layer is made of titanium oxides.

TABLE 3A

| Layer | | Refractive | Physical | Extinction |
|---|---|---|---|---|
| Sequence | Material | index | thickness (nm) | coefficient |
| Substrate | Glass | 1.52 | — | 0 |
| 1 | Ta₂O₅ | 2.14 | 11.5 | 0 |
| 2 | Al₂O₃ | 1.67 | 35.0 | 0 |
| 3 | Ta₂O₅ | 2.14 | 75.5 | 0 |
| 4 | Al₂O₃ | 1.67 | 6.2 | 0 |
| 5 | ab1 | 2.34 | 0~500 | 0.21 |
| 6 | ab2 | 2.11 | 0~500 | 0.17 |
| 7 | Al₂O₃ | 1.67 | 29.1 | 0 |
| 8 | Ta₂O₅ | 2.14 | 19.9 | 0 |
| 9 | Al₂O₃ | 1.22 | 120.0 | 0 |

Table 3B shows the values of TNG, Nab1, Nab2, Nab1/Narn, Tab1/Tab2, Tar1, Tar2 and TKP of Example 2.

TABLE 3B

| | | | |
|---|---|---|---|
| TNG (nm) | 120.0 | Tab1/Tab2 | 1.0 |
| Nab1 | 2.34 | Tar1 (nm) | 128.3 |
| Nab2 | 2.11 | Tar2 (nm) | 49.0 |
| Nab1/Narn | 1.40 | TKP (nm) | 1297.3 |

Table 3C shows the values of R4070-c, R4050-5, R4555-10, R5570-20, R4070-50 and R4070-p of the bokeh filter membrane of Example 2.

TABLE 3C

| | | | |
|---|---|---|---|
| R4070-c | 0.28 | R5570-20 | 0.87 |
| R4050-5 | 0.34 | R4070-50 | 0.29 |
| R4555-10 | 0.80 | R4070-p | 0.23 |

Table 3D shows the values of reflectance of the bokeh filter membrane of Example 2 in the wavelength range of 400 nm to 700 nm in which the gradient thickness absorbing membrane thereof is with different total membrane thicknesses.

TABLE 3D

| | Total membrane thickness of gradient | | | | | |
|---|---|---|---|---|---|---|
| | thickness absorbing membrane (nm) | | | | | |
| Wavelength | 0 | 50 | 100 | 200 | 500 | 1000 |
| (nm) | Reflectance (%) | | | | | |
| 400 | 2.00 | 1.27 | 1.63 | 1.82 | 0.99 | 1.12 |
| 405 | 1.56 | 1.17 | 1.49 | 1.51 | 0.80 | 1.02 |
| 410 | 1.22 | 1.04 | 1.39 | 1.22 | 0.71 | 0.96 |
| 415 | 0.98 | 0.89 | 1.32 | 0.96 | 0.67 | 0.88 |
| 420 | 0.80 | 0.73 | 1.26 | 0.74 | 0.65 | 0.77 |
| 425 | 0.67 | 0.57 | 1.23 | 0.58 | 0.65 | 0.64 |
| 430 | 0.57 | 0.42 | 1.20 | 0.45 | 0.64 | 0.52 |
| 435 | 0.50 | 0.29 | 1.18 | 0.36 | 0.62 | 0.41 |
| 440 | 0.45 | 0.19 | 1.15 | 0.30 | 0.59 | 0.33 |
| 445 | 0.40 | 0.11 | 1.12 | 0.24 | 0.54 | 0.28 |
| 450 | 0.37 | 0.05 | 1.08 | 0.20 | 0.47 | 0.26 |
| 455 | 0.33 | 0.03 | 1.03 | 0.17 | 0.40 | 0.25 |
| 460 | 0.30 | 0.01 | 0.99 | 0.14 | 0.32 | 0.25 |
| 465 | 0.27 | 0.01 | 0.94 | 0.11 | 0.25 | 0.24 |
| 470 | 0.24 | 0.01 | 0.90 | 0.09 | 0.18 | 0.23 |
| 475 | 0.22 | 0.02 | 0.85 | 0.07 | 0.12 | 0.21 |
| 480 | 0.20 | 0.03 | 0.81 | 0.05 | 0.08 | 0.19 |
| 485 | 0.17 | 0.04 | 0.78 | 0.05 | 0.05 | 0.16 |
| 490 | 0.16 | 0.05 | 0.75 | 0.04 | 0.03 | 0.13 |
| 495 | 0.14 | 0.06 | 0.73 | 0.04 | 0.02 | 0.11 |
| 500 | 0.13 | 0.07 | 0.72 | 0.05 | 0.02 | 0.08 |
| 505 | 0.11 | 0.08 | 0.71 | 0.06 | 0.02 | 0.06 |
| 510 | 0.11 | 0.08 | 0.70 | 0.07 | 0.03 | 0.05 |
| 515 | 0.10 | 0.08 | 0.71 | 0.09 | 0.04 | 0.05 |
| 520 | 0.09 | 0.08 | 0.71 | 0.11 | 0.05 | 0.05 |
| 525 | 0.09 | 0.08 | 0.72 | 0.13 | 0.06 | 0.05 |
| 530 | 0.09 | 0.07 | 0.72 | 0.15 | 0.06 | 0.06 |
| 535 | 0.09 | 0.07 | 0.73 | 0.18 | 0.07 | 0.07 |
| 540 | 0.09 | 0.06 | 0.74 | 0.21 | 0.08 | 0.09 |
| 545 | 0.09 | 0.05 | 0.74 | 0.24 | 0.09 | 0.10 |
| 550 | 0.09 | 0.05 | 0.74 | 0.27 | 0.09 | 0.11 |
| 555 | 0.09 | 0.04 | 0.74 | 0.31 | 0.10 | 0.12 |
| 560 | 0.10 | 0.03 | 0.74 | 0.35 | 0.11 | 0.13 |
| 565 | 0.10 | 0.03 | 0.73 | 0.40 | 0.12 | 0.14 |
| 570 | 0.10 | 0.02 | 0.72 | 0.45 | 0.13 | 0.14 |
| 575 | 0.10 | 0.01 | 0.70 | 0.50 | 0.14 | 0.15 |
| 580 | 0.10 | 0.01 | 0.68 | 0.55 | 0.16 | 0.16 |
| 585 | 0.10 | 0.01 | 0.66 | 0.61 | 0.18 | 0.16 |
| 590 | 0.10 | 0.01 | 0.63 | 0.67 | 0.20 | 0.16 |
| 595 | 0.10 | 0.00 | 0.60 | 0.72 | 0.22 | 0.16 |
| 600 | 0.10 | 0.00 | 0.57 | 0.78 | 0.24 | 0.16 |
| 605 | 0.10 | 0.00 | 0.54 | 0.84 | 0.26 | 0.16 |
| 610 | 0.10 | 0.00 | 0.51 | 0.89 | 0.29 | 0.16 |
| 615 | 0.10 | 0.01 | 0.47 | 0.94 | 0.31 | 0.15 |
| 620 | 0.10 | 0.01 | 0.44 | 0.99 | 0.33 | 0.15 |
| 625 | 0.10 | 0.01 | 0.40 | 1.03 | 0.35 | 0.14 |
| 630 | 0.10 | 0.01 | 0.37 | 1.07 | 0.37 | 0.13 |
| 635 | 0.10 | 0.01 | 0.34 | 1.10 | 0.38 | 0.13 |
| 640 | 0.11 | 0.01 | 0.30 | 1.13 | 0.39 | 0.13 |
| 645 | 0.11 | 0.01 | 0.27 | 1.15 | 0.40 | 0.12 |
| 650 | 0.12 | 0.01 | 0.24 | 1.16 | 0.40 | 0.12 |
| 655 | 0.13 | 0.01 | 0.22 | 1.17 | 0.39 | 0.12 |
| 660 | 0.14 | 0.01 | 0.19 | 1.17 | 0.39 | 0.12 |
| 665 | 0.16 | 0.01 | 0.17 | 1.16 | 0.38 | 0.12 |
| 670 | 0.18 | 0.01 | 0.14 | 1.15 | 0.36 | 0.12 |
| 675 | 0.20 | 0.00 | 0.12 | 1.13 | 0.34 | 0.12 |
| 680 | 0.23 | 0.00 | 0.11 | 1.11 | 0.32 | 0.12 |
| 685 | 0.26 | 0.00 | 0.09 | 1.08 | 0.29 | 0.12 |
| 690 | 0.29 | 0.00 | 0.08 | 1.04 | 0.27 | 0.12 |
| 695 | 0.33 | 0.00 | 0.06 | 1.00 | 0.24 | 0.12 |
| 700 | 0.37 | 0.00 | 0.05 | 0.95 | 0.21 | 0.11 |

### Example 3

A bokeh filter membrane of Example 3 is disposed on a surface of a substrate. The bokeh filter membrane includes a gradient thickness absorbing membrane and an anti-reflection membrane. The gradient thickness absorbing membrane includes a first gradient thickness absorbing membrane and a second gradient thickness absorbing membrane, and the anti-reflection membrane includes a high-and-low refraction membrane and a gradient refraction membrane. The high-and-low refraction membrane includes a first high-and-low refraction membrane and a second high-and-low refraction membrane. The first high-and-low refraction membrane includes an adjacent membrane layer, and the adjacent membrane layer is a layer of the first high-and-low refraction membrane closest to the first gradient thickness absorbing membrane.

The details of each layer of the bokeh filter membrane of Example 3 are shown in Table 4A, wherein “ab1” represents the layer is made of tantalum oxides, and “ab2” represents the layer is made of titanium oxides.

TABLE 4A

| Layer | | Refractive | Physical | Extinction |
|---|---|---|---|---|
| Sequence | Material | index | thickness (nm) | coefficient |
| Substrate | Glass | 1.52 | — | 0 |
| 1 | TiO₂ | 2.32 | 11.2 | 3.7E−04 |
| 2 | Al₂O₃ | 1.67 | 30.7 | 0 |
| 3 | TiO₂ | 2.32 | 80.3 | 3.7E−04 |
| 4 | Al₂O₃ | 1.67 | 4.9 | 0 |
| 5 | ab1 | 2.34 | 0~500 | 0.21 |
| 6 | ab2 | 2.11 | 0~500 | 0.17 |
| 7 | Al₂O₃ | 1.67 | 33.3 | 0 |
| 8 | TiO₂ | 2.32 | 11.5 | 3.7E−04 |
| 9 | Al₂O₃ | 1.22 | 120.0 | 0 |

Table 4B shows the values of TNG, Nab1, Nab2, Nab1/Narn, Tab1/Tab2, Tar1, Tar2 and TKP of Example 3.

TABLE 4B

| | | | |
|---|---|---|---|
| TNG (nm) | 120.0 | Tab1/Tab2 | 1.0 |
| Nab1 | 2.34 | Tar1 (nm) | 127.0 |
| Nab2 | 2.11 | Tar2 (nm) | 44.8 |
| Nab1/Narn | 1.40 | TKP (nm) | 1291.8 |

Table 4C shows the values of R4070-c, R4050-5, R4555-10, R5570-20, R4070-50 and R4070-p of the bokeh filter membrane of Example 3.

TABLE 4C

| | | | |
|---|---|---|---|
| R4070-c | 0.42 | R5570-20 | 0.69 |
| R4050-5 | 0.39 | R4070-50 | 0.16 |
| R4555-10 | 0.31 | R4070-p | 0.12 |

Table 4D shows the values of reflectance of the bokeh filter membrane of Example 3 in the wavelength range of 400 nm to 700 nm in which the gradient thickness absorbing membrane thereof is with different total membrane thicknesses.

TABLE 4D

| | Total membrane thickness of gradient | | | | | |
|---|---|---|---|---|---|---|
| | thickness absorbing membrane (nm) | | | | | |
| Wavelength | 0 | 50 | 100 | 200 | 500 | 1000 |
| (nm) | Reflectance (%) | | | | | |
| 400 | 1.28 | 1.08 | 1.25 | 1.43 | 0.53 | 0.69 |
| 405 | 0.77 | 1.09 | 0.99 | 1.11 | 0.44 | 0.63 |
| 410 | 0.42 | 1.04 | 0.78 | 0.79 | 0.43 | 0.58 |
| 415 | 0.20 | 0.94 | 0.64 | 0.51 | 0.45 | 0.52 |
| 420 | 0.08 | 0.79 | 0.55 | 0.30 | 0.46 | 0.44 |
| 425 | 0.02 | 0.64 | 0.51 | 0.17 | 0.45 | 0.35 |
| 430 | 0.01 | 0.49 | 0.49 | 0.10 | 0.44 | 0.28 |
| 435 | 0.01 | 0.34 | 0.49 | 0.08 | 0.41 | 0.23 |
| 440 | 0.03 | 0.23 | 0.49 | 0.08 | 0.37 | 0.20 |
| 445 | 0.05 | 0.14 | 0.49 | 0.10 | 0.33 | 0.20 |
| 450 | 0.07 | 0.08 | 0.48 | 0.13 | 0.28 | 0.22 |
| 455 | 0.08 | 0.04 | 0.45 | 0.15 | 0.23 | 0.23 |
| 460 | 0.08 | 0.03 | 0.42 | 0.17 | 0.17 | 0.24 |
| 465 | 0.08 | 0.04 | 0.38 | 0.19 | 0.12 | 0.23 |
| 470 | 0.08 | 0.06 | 0.34 | 0.20 | 0.08 | 0.22 |
| 475 | 0.07 | 0.10 | 0.29 | 0.20 | 0.06 | 0.20 |
| 480 | 0.05 | 0.14 | 0.25 | 0.21 | 0.05 | 0.17 |
| 485 | 0.04 | 0.18 | 0.22 | 0.23 | 0.06 | 0.14 |
| 490 | 0.03 | 0.23 | 0.19 | 0.24 | 0.08 | 0.11 |
| 495 | 0.02 | 0.27 | 0.17 | 0.26 | 0.11 | 0.09 |
| 500 | 0.02 | 0.30 | 0.17 | 0.28 | 0.13 | 0.08 |
| 505 | 0.02 | 0.33 | 0.17 | 0.31 | 0.15 | 0.08 |
| 510 | 0.02 | 0.35 | 0.19 | 0.34 | 0.17 | 0.09 |
| 515 | 0.02 | 0.36 | 0.21 | 0.36 | 0.18 | 0.10 |
| 520 | 0.03 | 0.37 | 0.24 | 0.39 | 0.18 | 0.10 |
| 525 | 0.05 | 0.37 | 0.28 | 0.42 | 0.17 | 0.11 |
| 530 | 0.07 | 0.36 | 0.32 | 0.45 | 0.16 | 0.10 |
| 535 | 0.09 | 0.34 | 0.36 | 0.47 | 0.15 | 0.10 |
| 540 | 0.11 | 0.33 | 0.40 | 0.49 | 0.13 | 0.08 |
| 545 | 0.14 | 0.30 | 0.44 | 0.51 | 0.12 | 0.07 |
| 550 | 0.17 | 0.28 | 0.48 | 0.52 | 0.10 | 0.06 |
| 555 | 0.20 | 0.26 | 0.51 | 0.54 | 0.09 | 0.04 |
| 560 | 0.23 | 0.23 | 0.54 | 0.55 | 0.08 | 0.03 |
| 565 | 0.27 | 0.21 | 0.56 | 0.56 | 0.08 | 0.03 |
| 570 | 0.30 | 0.18 | 0.57 | 0.58 | 0.07 | 0.02 |
| 575 | 0.33 | 0.16 | 0.59 | 0.59 | 0.07 | 0.01 |
| 580 | 0.37 | 0.14 | 0.59 | 0.61 | 0.07 | 0.01 |
| 585 | 0.40 | 0.12 | 0.59 | 0.63 | 0.07 | 0.01 |
| 590 | 0.43 | 0.10 | 0.58 | 0.65 | 0.07 | 0.01 |
| 595 | 0.47 | 0.08 | 0.57 | 0.67 | 0.08 | 0.00 |
| 600 | 0.50 | 0.07 | 0.56 | 0.69 | 0.08 | 0.00 |
| 605 | 0.53 | 0.05 | 0.54 | 0.71 | 0.08 | 0.00 |
| 610 | 0.57 | 0.04 | 0.52 | 0.73 | 0.09 | 0.00 |
| 615 | 0.60 | 0.03 | 0.50 | 0.75 | 0.09 | 0.00 |
| 620 | 0.63 | 0.03 | 0.48 | 0.76 | 0.10 | 0.00 |
| 625 | 0.66 | 0.02 | 0.46 | 0.78 | 0.10 | 0.00 |
| 630 | 0.70 | 0.02 | 0.43 | 0.79 | 0.10 | 0.00 |
| 635 | 0.73 | 0.01 | 0.41 | 0.80 | 0.11 | 0.00 |
| 640 | 0.77 | 0.01 | 0.39 | 0.81 | 0.11 | 0.00 |
| 645 | 0.81 | 0.01 | 0.37 | 0.81 | 0.11 | 0.00 |
| 650 | 0.85 | 0.00 | 0.35 | 0.81 | 0.10 | 0.01 |
| 655 | 0.89 | 0.00 | 0.33 | 0.80 | 0.10 | 0.01 |
| 660 | 0.93 | 0.00 | 0.32 | 0.79 | 0.09 | 0.01 |
| 665 | 0.98 | 0.00 | 0.31 | 0.78 | 0.08 | 0.02 |
| 670 | 1.03 | 0.00 | 0.30 | 0.76 | 0.07 | 0.02 |
| 675 | 1.08 | 0.00 | 0.29 | 0.73 | 0.06 | 0.02 |
| 680 | 1.13 | 0.00 | 0.28 | 0.71 | 0.05 | 0.03 |
| 685 | 1.19 | 0.00 | 0.28 | 0.68 | 0.04 | 0.03 |
| 690 | 1.25 | 0.01 | 0.27 | 0.65 | 0.03 | 0.03 |
| 695 | 1.32 | 0.01 | 0.27 | 0.61 | 0.02 | 0.04 |
| 700 | 1.38 | 0.01 | 0.28 | 0.57 | 0.02 | 0.04 |

### Example 4

A bokeh filter membrane of Example 4 is disposed on a surface of a substrate. The bokeh filter membrane includes a gradient thickness absorbing membrane and an anti-reflection membrane. The gradient thickness absorbing membrane includes a first gradient thickness absorbing membrane and a second gradient thickness absorbing membrane, and the anti-reflection membrane includes a high-and-low refraction membrane and a gradient refraction membrane. The high-and-low refraction membrane includes a first high-and-low refraction membrane and a second high-and-low refraction membrane. The first high-and-low refraction membrane includes an adjacent membrane layer, and the adjacent membrane layer is a layer of the first high-and-low refraction membrane closest to the first gradient thickness absorbing membrane.

The details of each layer of the bokeh filter membrane of Example 4 are shown in Table 5A, wherein “ab1” represents the layer is made of tantalum oxides, and “ab2” represents the layer is made of titanium oxides.

TABLE 5A

| Layer | | Refractive | Physical | Extinction |
|---|---|---|---|---|
| Sequence | Material | index | thickness (nm) | coefficient |
| Substrate | Glass | 1.52 | — | 0 |
| 1 | Nb₂O₅ | 2.29 | 14.1 | 0 |
| 2 | SiO₂ | 1.46 | 25.4 | 0 |
| 3 | Nb₂O₅ | 2.29 | 97.4 | 0 |
| 4 | SiO₂ | 1.46 | 4.5 | 0 |
| 5 | ab1 | 2.34 | 0~500 | 0.21 |
| 6 | ab2 | 2.11 | 0~500 | 0.17 |
| 7 | SiO₂ | 1.46 | 23.5 | 0 |
| 8 | Nb₂O₅ | 2.29 | 17.7 | 0 |
| 9 | Al₂O₃ | 1.22 | 120.0 | 0 |

Table 5B shows the values of TNG, Nab1, Nab2, Nab1/Narn, Tab1/Tab2, Tar1, Tar2 and TKP of Example 4.

TABLE 5B

| | | | |
|---|---|---|---|
| TNG (nm) | 120.0 | Tab1/Tab2 | 1.0 |
| Nab1 | 2.34 | Tar1 (nm) | 141.4 |
| Nab2 | 2.11 | Tar2 (nm) | 41.2 |
| Nab1/Narn | 1.60 | TKP (nm) | 1302.6 |

Table 5C shows the values of R4070-c, R4050-5, R4555-10, R5570-20, R4070-50 and R4070-p of the bokeh filter membrane of Example 4.

TABLE 5C

| | | | |
|---|---|---|---|
| R4070-c | 0.31 | R5570-20 | 0.60 |
| R4050-5 | 0.24 | R4070-50 | 0.15 |
| R4555-10 | 0.55 | R4070-p | 0.12 |

Table 5D shows the values of reflectance of the bokeh filter membrane of Example 4 in the wavelength range of 400 nm to 700 nm in which the gradient thickness absorbing membrane thereof is with different total membrane thicknesses.

TABLE 5D

| | Total membrane thickness of gradient | | | | | |
|---|---|---|---|---|---|---|
| | thickness absorbing membrane (nm) | | | | | |
| Wavelength | 0 | 50 | 100 | 200 | 500 | 1000 |
| (nm) | Reflectance (%) | | | | | |
| 400 | 2.22 | 0.75 | 1.87 | 1.31 | 0.83 | 0.98 |
| 405 | 1.65 | 0.63 | 1.74 | 1.11 | 0.63 | 0.88 |
| 410 | 1.19 | 0.53 | 1.56 | 0.89 | 0.55 | 0.79 |
| 415 | 0.84 | 0.43 | 1.38 | 0.68 | 0.53 | 0.68 |
| 420 | 0.57 | 0.34 | 1.21 | 0.49 | 0.53 | 0.54 |
| 425 | 0.40 | 0.28 | 1.08 | 0.36 | 0.53 | 0.43 |
| 430 | 0.28 | 0.21 | 0.97 | 0.26 | 0.52 | 0.33 |
| 435 | 0.20 | 0.15 | 0.87 | 0.19 | 0.48 | 0.26 |
| 440 | 0.15 | 0.10 | 0.80 | 0.15 | 0.43 | 0.22 |
| 445 | 0.12 | 0.06 | 0.73 | 0.12 | 0.37 | 0.20 |
| 450 | 0.10 | 0.03 | 0.67 | 0.11 | 0.30 | 0.19 |
| 455 | 0.09 | 0.01 | 0.62 | 0.11 | 0.23 | 0.19 |
| 460 | 0.09 | 0.01 | 0.57 | 0.10 | 0.16 | 0.18 |
| 465 | 0.08 | 0.03 | 0.53 | 0.10 | 0.10 | 0.17 |
| 470 | 0.08 | 0.06 | 0.49 | 0.10 | 0.06 | 0.16 |
| 475 | 0.07 | 0.10 | 0.45 | 0.10 | 0.03 | 0.13 |
| 480 | 0.07 | 0.15 | 0.43 | 0.10 | 0.01 | 0.11 |
| 485 | 0.06 | 0.20 | 0.40 | 0.10 | 0.01 | 0.08 |
| 490 | 0.05 | 0.26 | 0.39 | 0.10 | 0.03 | 0.06 |
| 495 | 0.04 | 0.32 | 0.39 | 0.11 | 0.05 | 0.04 |
| 500 | 0.03 | 0.38 | 0.40 | 0.12 | 0.07 | 0.04 |
| 505 | 0.03 | 0.43 | 0.41 | 0.13 | 0.10 | 0.03 |
| 510 | 0.02 | 0.48 | 0.44 | 0.15 | 0.11 | 0.04 |
| 515 | 0.02 | 0.52 | 0.48 | 0.17 | 0.13 | 0.05 |
| 520 | 0.02 | 0.55 | 0.52 | 0.19 | 0.13 | 0.05 |
| 525 | 0.02 | 0.58 | 0.58 | 0.22 | 0.13 | 0.06 |
| 530 | 0.02 | 0.59 | 0.64 | 0.24 | 0.12 | 0.06 |
| 535 | 0.03 | 0.58 | 0.70 | 0.26 | 0.10 | 0.05 |
| 540 | 0.04 | 0.58 | 0.76 | 0.27 | 0.09 | 0.04 |
| 545 | 0.05 | 0.56 | 0.82 | 0.29 | 0.07 | 0.03 |
| 550 | 0.06 | 0.55 | 0.87 | 0.31 | 0.06 | 0.03 |
| 555 | 0.08 | 0.53 | 0.92 | 0.33 | 0.05 | 0.02 |
| 560 | 0.09 | 0.51 | 0.97 | 0.35 | 0.04 | 0.01 |
| 565 | 0.11 | 0.48 | 1.01 | 0.37 | 0.04 | 0.01 |
| 570 | 0.13 | 0.46 | 1.04 | 0.39 | 0.03 | 0.01 |
| 575 | 0.14 | 0.43 | 1.06 | 0.41 | 0.03 | 0.01 |
| 580 | 0.16 | 0.41 | 1.08 | 0.44 | 0.03 | 0.01 |
| 585 | 0.18 | 0.39 | 1.09 | 0.47 | 0.03 | 0.00 |
| 590 | 0.19 | 0.36 | 1.09 | 0.49 | 0.03 | 0.00 |
| 595 | 0.21 | 0.34 | 1.08 | 0.52 | 0.03 | 0.00 |
| 600 | 0.23 | 0.32 | 1.08 | 0.55 | 0.04 | 0.00 |
| 605 | 0.24 | 0.30 | 1.06 | 0.58 | 0.04 | 0.00 |
| 610 | 0.26 | 0.28 | 1.05 | 0.61 | 0.05 | 0.00 |
| 615 | 0.27 | 0.27 | 1.03 | 0.64 | 0.05 | 0.00 |
| 620 | 0.29 | 0.25 | 1.00 | 0.67 | 0.06 | 0.00 |
| 625 | 0.30 | 0.24 | 0.98 | 0.70 | 0.07 | 0.00 |
| 630 | 0.32 | 0.22 | 0.96 | 0.72 | 0.07 | 0.00 |
| 635 | 0.34 | 0.21 | 0.93 | 0.74 | 0.07 | 0.00 |
| 640 | 0.35 | 0.20 | 0.91 | 0.75 | 0.08 | 0.00 |
| 645 | 0.37 | 0.19 | 0.88 | 0.77 | 0.08 | 0.00 |
| 650 | 0.39 | 0.18 | 0.86 | 0.77 | 0.08 | 0.00 |
| 655 | 0.41 | 0.17 | 0.84 | 0.78 | 0.08 | 0.01 |
| 660 | 0.43 | 0.16 | 0.82 | 0.77 | 0.07 | 0.01 |
| 665 | 0.45 | 0.16 | 0.81 | 0.76 | 0.07 | 0.01 |
| 670 | 0.48 | 0.15 | 0.80 | 0.75 | 0.06 | 0.01 |
| 675 | 0.51 | 0.14 | 0.79 | 0.74 | 0.05 | 0.02 |
| 680 | 0.54 | 0.14 | 0.78 | 0.71 | 0.04 | 0.02 |
| 685 | 0.57 | 0.13 | 0.78 | 0.69 | 0.03 | 0.03 |
| 690 | 0.61 | 0.12 | 0.78 | 0.66 | 0.02 | 0.03 |
| 695 | 0.65 | 0.12 | 0.78 | 0.62 | 0.02 | 0.04 |
| 700 | 0.70 | 0.12 | 0.79 | 0.59 | 0.01 | 0.04 |

### Example 5

A bokeh filter membrane of Example 5 is disposed on a surface of a substrate. The bokeh filter membrane includes a gradient thickness absorbing membrane and an anti-reflection membrane. The gradient thickness absorbing membrane includes a first gradient thickness absorbing membrane and a second gradient thickness absorbing membrane, and the anti-reflection membrane includes a high-and-low refraction membrane and a gradient refraction membrane. The high-and-low refraction membrane includes a first high-and-low refraction membrane and a second high-and-low refraction membrane. The first high-and-low refraction membrane includes an adjacent membrane layer, and the adjacent membrane layer is a layer of the first high-and-low refraction membrane closest to the first gradient thickness absorbing membrane.

The details of each layer of the bokeh filter membrane of Example 5 are shown in Table 6A, wherein “ab1” represents the layer is made of tantalum oxides, and “ab2” represents the layer is made of titanium oxides.

TABLE 6A

| Layer | | Refractive | Physical | Extinction |
|---|---|---|---|---|
| Sequence | Material | index | thickness (nm) | coefficient |
| Substrate | Glass | 1.52 | — | 0 |
| 1 | Ta₂O₅ | 2.14 | 16.7 | 0 |
| 2 | SiO₂ | 1.46 | 24.1 | 0 |
| 3 | Ta₂O₅ | 2.14 | 81.9 | 0 |
| 4 | SiO₂ | 1.46 | 3.9 | 0 |
| 5 | ab1 | 2.34 | 0~500 | 0.21 |
| 6 | ab2 | 2.11 | 0~500 | 0.17 |
| 7 | SiO₂ | 1.46 | 20.3 | 0 |
| 8 | Ta₂O₅ | 2.14 | 24.1 | 0 |
| 9 | Al₂O₃ | 1.22 | 120.0 | 0 |

Table 6B shows the values of TNG, Nab1, Nab2, Nab1/Narn, Tab1/Tab2, Tar1, Tar2 and TKP of Example 5.

TABLE 6B

| | | | |
|---|---|---|---|
| TNG (nm) | 120.0 | Tab1/Tab2 | 1.0 |
| Nab1 | 2.34 | Tar1 (nm) | 126.6 |
| Nab2 | 2.11 | Tar2 (nm) | 44.5 |
| Nab1/Narn | 1.60 | TKP (nm) | 1291.0 |

Table 6C shows the values of R4070-c, R4050-5, R4555-10, R5570-20, R4070-50 and R4070-p of the bokeh filter membrane of Example 5.

TABLE 6C

| | | | |
|---|---|---|---|
| R4070-c | 0.23 | R5570-20 | 0.70 |
| R4050-5 | 0.36 | R4070-50 | 0.22 |
| R4555-10 | 0.58 | R4070-p | 0.17 |

Table 6D shows the values of reflectance of the bokeh filter membrane of Example 5 in the wavelength range of 400 nm to 700 nm in which the gradient thickness absorbing membrane thereof is with different total membrane thicknesses.

TABLE 6D

| | Total membrane thickness of gradient | | | | | |
|---|---|---|---|---|---|---|
| | thickness absorbing membrane (nm) | | | | | |
| Wavelength | 0 | 50 | 100 | 200 | 500 | 1000 |
| (nm) | Reflectance (%) | | | | | |
| 400 | 1.24 | 1.50 | 1.51 | 1.64 | 0.89 | 1.07 |
| 405 | 0.94 | 1.31 | 1.38 | 1.29 | 0.76 | 0.99 |
| 410 | 0.73 | 1.11 | 1.29 | 0.99 | 0.71 | 0.93 |
| 415 | 0.58 | 0.90 | 1.23 | 0.74 | 0.68 | 0.83 |
| 420 | 0.47 | 0.69 | 1.18 | 0.56 | 0.67 | 0.70 |
| 425 | 0.40 | 0.51 | 1.14 | 0.43 | 0.65 | 0.57 |
| 430 | 0.35 | 0.35 | 1.10 | 0.34 | 0.63 | 0.44 |
| 435 | 0.31 | 0.22 | 1.05 | 0.27 | 0.59 | 0.35 |
| 440 | 0.27 | 0.13 | 1.00 | 0.23 | 0.54 | 0.29 |
| 445 | 0.24 | 0.07 | 0.94 | 0.19 | 0.47 | 0.26 |
| 450 | 0.21 | 0.03 | 0.87 | 0.17 | 0.38 | 0.24 |
| 455 | 0.19 | 0.02 | 0.81 | 0.15 | 0.31 | 0.24 |
| 460 | 0.17 | 0.02 | 0.75 | 0.13 | 0.23 | 0.24 |
| 465 | 0.15 | 0.03 | 0.70 | 0.11 | 0.16 | 0.22 |
| 470 | 0.12 | 0.05 | 0.65 | 0.10 | 0.11 | 0.21 |
| 475 | 0.10 | 0.06 | 0.60 | 0.09 | 0.06 | 0.18 |
| 480 | 0.09 | 0.08 | 0.56 | 0.08 | 0.04 | 0.15 |
| 485 | 0.07 | 0.10 | 0.53 | 0.08 | 0.02 | 0.12 |
| 490 | 0.06 | 0.12 | 0.50 | 0.08 | 0.02 | 0.09 |
| 495 | 0.04 | 0.13 | 0.49 | 0.09 | 0.02 | 0.07 |
| 500 | 0.03 | 0.15 | 0.48 | 0.10 | 0.03 | 0.05 |
| 505 | 0.03 | 0.15 | 0.48 | 0.11 | 0.04 | 0.04 |
| 510 | 0.02 | 0.16 | 0.48 | 0.13 | 0.05 | 0.03 |
| 515 | 0.02 | 0.16 | 0.49 | 0.15 | 0.06 | 0.03 |
| 520 | 0.02 | 0.16 | 0.50 | 0.16 | 0.06 | 0.04 |
| 525 | 0.02 | 0.15 | 0.52 | 0.18 | 0.07 | 0.04 |
| 530 | 0.02 | 0.14 | 0.54 | 0.20 | 0.07 | 0.05 |
| 535 | 0.03 | 0.13 | 0.55 | 0.23 | 0.07 | 0.05 |
| 540 | 0.03 | 0.12 | 0.57 | 0.25 | 0.07 | 0.06 |
| 545 | 0.03 | 0.11 | 0.58 | 0.27 | 0.07 | 0.06 |
| 550 | 0.04 | 0.10 | 0.59 | 0.30 | 0.07 | 0.06 |
| 555 | 0.05 | 0.09 | 0.60 | 0.33 | 0.07 | 0.07 |
| 560 | 0.05 | 0.07 | 0.60 | 0.36 | 0.08 | 0.07 |
| 565 | 0.06 | 0.06 | 0.60 | 0.39 | 0.08 | 0.07 |
| 570 | 0.07 | 0.05 | 0.59 | 0.43 | 0.09 | 0.08 |
| 575 | 0.07 | 0.04 | 0.58 | 0.47 | 0.10 | 0.08 |
| 580 | 0.08 | 0.03 | 0.57 | 0.51 | 0.11 | 0.08 |
| 585 | 0.09 | 0.03 | 0.55 | 0.55 | 0.12 | 0.08 |
| 590 | 0.09 | 0.02 | 0.53 | 0.59 | 0.13 | 0.08 |
| 595 | 0.10 | 0.02 | 0.51 | 0.63 | 0.15 | 0.08 |
| 600 | 0.11 | 0.01 | 0.48 | 0.67 | 0.16 | 0.08 |
| 605 | 0.11 | 0.01 | 0.46 | 0.71 | 0.18 | 0.08 |
| 610 | 0.12 | 0.01 | 0.43 | 0.75 | 0.19 | 0.07 |
| 615 | 0.13 | 0.01 | 0.40 | 0.79 | 0.21 | 0.07 |
| 620 | 0.14 | 0.00 | 0.37 | 0.82 | 0.22 | 0.06 |
| 625 | 0.15 | 0.00 | 0.35 | 0.85 | 0.23 | 0.06 |
| 630 | 0.17 | 0.00 | 0.32 | 0.87 | 0.24 | 0.06 |
| 635 | 0.18 | 0.00 | 0.29 | 0.89 | 0.25 | 0.05 |
| 640 | 0.20 | 0.00 | 0.26 | 0.90 | 0.25 | 0.05 |
| 645 | 0.22 | 0.00 | 0.24 | 0.91 | 0.25 | 0.05 |
| 650 | 0.24 | 0.00 | 0.22 | 0.91 | 0.25 | 0.05 |
| 655 | 0.27 | 0.01 | 0.19 | 0.91 | 0.24 | 0.05 |
| 660 | 0.30 | 0.01 | 0.17 | 0.90 | 0.23 | 0.05 |
| 665 | 0.33 | 0.01 | 0.16 | 0.88 | 0.22 | 0.05 |
| 670 | 0.36 | 0.01 | 0.14 | 0.86 | 0.20 | 0.05 |
| 675 | 0.40 | 0.01 | 0.13 | 0.84 | 0.19 | 0.05 |
| 680 | 0.45 | 0.02 | 0.11 | 0.81 | 0.17 | 0.05 |
| 685 | 0.49 | 0.02 | 0.10 | 0.77 | 0.15 | 0.05 |
| 690 | 0.54 | 0.03 | 0.09 | 0.73 | 0.13 | 0.06 |
| 695 | 0.60 | 0.04 | 0.09 | 0.69 | 0.11 | 0.06 |
| 700 | 0.66 | 0.05 | 0.08 | 0.65 | 0.09 | 0.06 |

### Example 6

A bokeh filter membrane of Example 6 is disposed on a surface of a substrate. The bokeh filter membrane includes a gradient thickness absorbing membrane and an anti-reflection membrane. The gradient thickness absorbing membrane includes a first gradient thickness absorbing membrane and a second gradient thickness absorbing membrane, and the anti-reflection membrane includes a high-and-low refraction membrane and a gradient refraction membrane. The high-and-low refraction membrane includes a first high-and-low refraction membrane and a second high-and-low refraction membrane. The first high-and-low refraction membrane includes an adjacent membrane layer, and the adjacent membrane layer is a layer of the first high-and-low refraction membrane closest to the first gradient thickness absorbing membrane.

The details of each layer of the bokeh filter membrane of Example 6 are shown in Table 7A, wherein “ab1” represents the layer is made of tantalum oxides, and “ab2” represents the layer is made of titanium oxides.

TABLE 7A

| Layer | | Refractive | Physical | Extinction |
|---|---|---|---|---|
| Sequence | Material | index | thickness (nm) | coefficient |
| Substrate | Glass | 1.52 | — | 0 |
| 1 | TiO₂ | 2.35 | 15.0 | 3.7E−04 |
| 2 | SiO₂ | 1.46 | 25.0 | 0 |
| 3 | TiO₂ | 2.35 | 95.0 | 3.7E−04 |
| 4 | SiO₂ | 1.46 | 2.0 | 0 |
| 5 | ab1 | 2.34 | 0~500 | 0.21 |
| 6 | ab2 | 2.11 | 0~500 | 0.17 |
| 7 | SiO₂ | 1.46 | 25.0 | 0 |
| 8 | TiO₂ | 2.35 | 15.0 | 3.7E−04 |
| 9 | Al₂O₃ | 1.22 | 200.0 | 0 |

Table 7B shows the values of TNG, Nab1, Nab2, Nab1/Narn, Tab1/Tab2, Tall, Tar2 and TKP of Example 6.

TABLE 7B

| | | | |
|---|---|---|---|
| TNG (nm) | 200.0 | Tab1/Tab2 | 1.0 |
| Nab1 | 2.34 | Tar1 (nm) | 137.0 |
| Nab2 | 2.11 | Tar2 (nm) | 40.0 |
| Nab1/Narn | 1.60 | TKP (nm) | 1377.0 |

Table 7C shows the values of R4070-c, R4050-5, R4555-10, R5570-20, R4070-50 and R4070-p of the bokeh filter membrane of Example 6.

TABLE 7C

| | | | |
|---|---|---|---|
| R4070-c | 0.35 | R5570-20 | 0.41 |
| R4050-5 | 0.30 | R4070-50 | 0.13 |
| R4555-10 | 0.32 | R4070-p | 0.12 |

Table 7D shows the values of reflectance of the bokeh filter membrane of Example 6 in the wavelength range of 400 nm to 700 nm in which the gradient thickness absorbing membrane thereof is with different total membrane thicknesses.

TABLE 7D

| | Total membrane thickness of gradient | | | | | |
|---|---|---|---|---|---|---|
| | thickness absorbing membrane (nm) | | | | | |
| Wavelength | 0 | 50 | 100 | 200 | 500 | 1000 |
| (nm) | Reflectance (%) | | | | | |
| 400 | 2.00 | 0.78 | 1.68 | 1.22 | 0.78 | 0.92 |
| 405 | 1.30 | 0.68 | 1.47 | 1.01 | 0.57 | 0.79 |
| 410 | 0.76 | 0.63 | 1.21 | 0.76 | 0.49 | 0.69 |
| 415 | 0.40 | 0.59 | 0.97 | 0.52 | 0.47 | 0.57 |
| 420 | 0.17 | 0.52 | 0.76 | 0.32 | 0.46 | 0.45 |
| 425 | 0.06 | 0.45 | 0.61 | 0.17 | 0.44 | 0.33 |
| 430 | 0.02 | 0.35 | 0.51 | 0.09 | 0.40 | 0.24 |
| 435 | 0.03 | 0.26 | 0.45 | 0.06 | 0.35 | 0.18 |
| 440 | 0.07 | 0.17 | 0.42 | 0.07 | 0.30 | 0.15 |
| 445 | 0.13 | 0.10 | 0.40 | 0.11 | 0.25 | 0.15 |
| 450 | 0.19 | 0.04 | 0.39 | 0.16 | 0.20 | 0.16 |
| 455 | 0.24 | 0.01 | 0.37 | 0.20 | 0.15 | 0.17 |
| 460 | 0.29 | 0.01 | 0.35 | 0.24 | 0.11 | 0.18 |
| 465 | 0.32 | 0.02 | 0.33 | 0.26 | 0.07 | 0.17 |
| 470 | 0.33 | 0.06 | 0.30 | 0.27 | 0.05 | 0.15 |
| 475 | 0.34 | 0.11 | 0.27 | 0.28 | 0.03 | 0.13 |
| 480 | 0.33 | 0.18 | 0.23 | 0.27 | 0.03 | 0.11 |
| 485 | 0.32 | 0.25 | 0.21 | 0.26 | 0.05 | 0.09 |
| 490 | 0.29 | 0.32 | 0.18 | 0.24 | 0.08 | 0.08 |
| 495 | 0.27 | 0.40 | 0.17 | 0.23 | 0.11 | 0.07 |
| 500 | 0.23 | 0.47 | 0.17 | 0.22 | 0.15 | 0.07 |
| 505 | 0.20 | 0.54 | 0.18 | 0.21 | 0.18 | 0.08 |
| 510 | 0.17 | 0.59 | 0.20 | 0.21 | 0.20 | 0.09 |
| 515 | 0.14 | 0.64 | 0.23 | 0.21 | 0.22 | 0.10 |
| 520 | 0.11 | 0.68 | 0.27 | 0.22 | 0.22 | 0.11 |
| 525 | 0.09 | 0.70 | 0.33 | 0.23 | 0.21 | 0.11 |
| 530 | 0.07 | 0.72 | 0.38 | 0.23 | 0.20 | 0.10 |
| 535 | 0.05 | 0.72 | 0.45 | 0.24 | 0.18 | 0.09 |
| 540 | 0.04 | 0.72 | 0.52 | 0.25 | 0.15 | 0.08 |
| 545 | 0.04 | 0.71 | 0.58 | 0.26 | 0.13 | 0.06 |
| 550 | 0.03 | 0.69 | 0.65 | 0.27 | 0.11 | 0.04 |
| 555 | 0.04 | 0.66 | 0.71 | 0.28 | 0.09 | 0.03 |
| 560 | 0.04 | 0.63 | 0.77 | 0.28 | 0.07 | 0.02 |
| 565 | 0.05 | 0.60 | 0.82 | 0.29 | 0.06 | 0.01 |
| 570 | 0.06 | 0.57 | 0.87 | 0.30 | 0.05 | 0.01 |
| 575 | 0.08 | 0.54 | 0.91 | 0.31 | 0.04 | 0.01 |
| 580 | 0.09 | 0.50 | 0.94 | 0.32 | 0.03 | 0.00 |
| 585 | 0.11 | 0.46 | 0.96 | 0.33 | 0.03 | 0.00 |
| 590 | 0.13 | 0.43 | 0.98 | 0.34 | 0.03 | 0.00 |
| 595 | 0.16 | 0.40 | 0.99 | 0.36 | 0.02 | 0.00 |
| 600 | 0.18 | 0.37 | 0.99 | 0.37 | 0.02 | 0.01 |
| 605 | 0.21 | 0.34 | 0.99 | 0.39 | 0.02 | 0.01 |
| 610 | 0.24 | 0.31 | 0.98 | 0.41 | 0.02 | 0.01 |
| 615 | 0.26 | 0.28 | 0.97 | 0.42 | 0.02 | 0.01 |
| 620 | 0.29 | 0.26 | 0.96 | 0.44 | 0.02 | 0.01 |
| 625 | 0.32 | 0.24 | 0.94 | 0.46 | 0.02 | 0.01 |
| 630 | 0.36 | 0.22 | 0.92 | 0.47 | 0.02 | 0.01 |
| 635 | 0.39 | 0.20 | 0.90 | 0.48 | 0.03 | 0.02 |
| 640 | 0.42 | 0.18 | 0.88 | 0.49 | 0.03 | 0.02 |
| 645 | 0.46 | 0.17 | 0.86 | 0.50 | 0.03 | 0.02 |
| 650 | 0.50 | 0.15 | 0.84 | 0.51 | 0.02 | 0.02 |
| 655 | 0.54 | 0.14 | 0.82 | 0.51 | 0.02 | 0.02 |
| 660 | 0.59 | 0.13 | 0.81 | 0.51 | 0.02 | 0.03 |
| 665 | 0.63 | 0.12 | 0.79 | 0.50 | 0.02 | 0.03 |
| 670 | 0.68 | 0.12 | 0.78 | 0.50 | 0.01 | 0.04 |
| 675 | 0.74 | 0.11 | 0.77 | 0.48 | 0.01 | 0.04 |
| 680 | 0.79 | 0.11 | 0.76 | 0.47 | 0.01 | 0.04 |
| 685 | 0.85 | 0.10 | 0.76 | 0.45 | 0.01 | 0.05 |
| 690 | 0.91 | 0.10 | 0.76 | 0.43 | 0.01 | 0.05 |
| 695 | 0.98 | 0.10 | 0.76 | 0.41 | 0.01 | 0.06 |
| 700 | 1.05 | 0.10 | 0.76 | 0.38 | 0.01 | 0.07 |

### Example 7

A bokeh filter membrane of Example 7 is disposed on a surface of a substrate. The bokeh filter membrane includes a gradient thickness absorbing membrane and an anti-reflection membrane. The gradient thickness absorbing membrane includes a first gradient thickness absorbing membrane and a second gradient thickness absorbing membrane, and the anti-reflection membrane includes a high-and-low refraction membrane and a gradient refraction membrane. The high-and-low refraction membrane includes a first high-and-low refraction membrane and a second high-and-low refraction membrane. The first high-and-low refraction membrane includes an adjacent membrane layer, and the adjacent membrane layer is a layer of the first high-and-low refraction membrane closest to the first gradient thickness absorbing membrane.

The details of each layer of the bokeh filter membrane of Example 7 are shown in Table 8A, wherein “ab1” represents the layer is made of tantalum oxides, and “ab2” represents the layer is made of titanium oxides.

TABLE 8A

| Layer | | Refractive | Physical | Extinction |
|---|---|---|---|---|
| Sequence | Material | index | thickness (nm) | coefficient |
| Substrate | Glass | 1.52 | — | 0 |
| 1 | ZrO₂ | 2.07 | 12.0 | 4.0E−05 |
| 2 | Al₂O₃ | 1.67 | 35.0 | 0 |
| 3 | ZrO₂ | 2.07 | 70.0 | 4.0E−05 |
| 4 | Al₂O₃ | 1.67 | 8.0 | 0 |
| 5 | ab1 | 2.34 | 0~500 | 0.21 |
| 6 | ab2 | 2.11 | 0~500 | 0.17 |
| 7 | Al₂O₃ | 1.67 | 33.0 | 0 |
| 8 | ZrO₂ | 2.07 | 15.0 | 4.0E−05 |
| 9 | Al₂O₃ | 1.22 | 200.0 | 0 |

Table 8B shows the values of TNG, Nab1, Nab2, Nab1/Narn, Tab1/Tab2, Tar1, Tar2 and TKP of Example 7.

TABLE 8B

| | | | |
|---|---|---|---|
| TNG (nm) | 200.0 | Tab1/Tab2 | 1.0 |
| Nab1 | 2.34 | Tar1 (nm) | 125.0 |
| Nab2 | 2.11 | Tar2 (nm) | 48.0 |
| Nab1/Narn | 1.40 | TKP (nm) | 1373.0 |

Table 8C shows the values of R4070-c, R4050-5, R4555-10, R5570-20, R4070-50 and R4070-p of the bokeh filter membrane of Example 7.

TABLE 8C

| | | | |
|---|---|---|---|
| R4070-c | 0.24 | R5570-20 | 0.35 |
| R4050-5 | 0.53 | R4070-50 | 0.20 |
| R4555-10 | 0.32 | R4070-p | 0.17 |

Table 8D shows the values of reflectance of the bokeh filter membrane of Example 7 in the wavelength range of 400 nm to 700 nm in which the gradient thickness absorbing membrane thereof is with different total membrane thicknesses.

TABLE 8D

| | Total membrane thickness of gradient | | | | | |
|---|---|---|---|---|---|---|
| | thickness absorbing membrane (nm) | | | | | |
| Wavelength | 0 | 50 | 100 | 200 | 500 | 1000 |
| (nm) | Reflectance (%) | | | | | |
| 400 | 0.35 | 0.37 | 0.95 | 0.46 | 0.26 | 0.39 |
| 405 | 0.31 | 0.30 | 1.02 | 0.40 | 0.32 | 0.44 |
| 410 | 0.30 | 0.24 | 1.08 | 0.37 | 0.40 | 0.47 |
| 415 | 0.29 | 0.19 | 1.11 | 0.35 | 0.49 | 0.45 |
| 420 | 0.29 | 0.17 | 1.11 | 0.35 | 0.57 | 0.41 |
| 425 | 0.28 | 0.18 | 1.09 | 0.35 | 0.61 | 0.37 |
| 430 | 0.27 | 0.20 | 1.04 | 0.35 | 0.63 | 0.35 |
| 435 | 0.26 | 0.25 | 0.97 | 0.34 | 0.60 | 0.35 |
| 440 | 0.24 | 0.31 | 0.89 | 0.33 | 0.55 | 0.38 |
| 445 | 0.22 | 0.38 | 0.79 | 0.32 | 0.47 | 0.41 |
| 450 | 0.19 | 0.45 | 0.69 | 0.30 | 0.38 | 0.44 |
| 455 | 0.16 | 0.54 | 0.58 | 0.29 | 0.30 | 0.45 |
| 460 | 0.14 | 0.61 | 0.48 | 0.28 | 0.23 | 0.45 |
| 465 | 0.11 | 0.69 | 0.38 | 0.27 | 0.19 | 0.43 |
| 470 | 0.09 | 0.76 | 0.30 | 0.28 | 0.17 | 0.40 |
| 475 | 0.07 | 0.82 | 0.23 | 0.29 | 0.17 | 0.36 |
| 480 | 0.05 | 0.87 | 0.18 | 0.32 | 0.20 | 0.32 |
| 485 | 0.03 | 0.91 | 0.14 | 0.35 | 0.24 | 0.28 |
| 490 | 0.02 | 0.94 | 0.11 | 0.39 | 0.29 | 0.25 |
| 495 | 0.02 | 0.95 | 0.11 | 0.42 | 0.33 | 0.22 |
| 500 | 0.01 | 0.96 | 0.11 | 0.46 | 0.36 | 0.22 |
| 505 | 0.01 | 0.95 | 0.13 | 0.50 | 0.38 | 0.22 |
| 510 | 0.02 | 0.94 | 0.17 | 0.53 | 0.39 | 0.23 |
| 515 | 0.02 | 0.92 | 0.21 | 0.56 | 0.38 | 0.24 |
| 520 | 0.03 | 0.89 | 0.25 | 0.58 | 0.37 | 0.24 |
| 525 | 0.04 | 0.86 | 0.31 | 0.59 | 0.34 | 0.23 |
| 530 | 0.05 | 0.83 | 0.36 | 0.59 | 0.31 | 0.21 |
| 535 | 0.07 | 0.79 | 0.42 | 0.59 | 0.27 | 0.19 |
| 540 | 0.08 | 0.75 | 0.47 | 0.58 | 0.24 | 0.16 |
| 545 | 0.10 | 0.70 | 0.53 | 0.56 | 0.21 | 0.13 |
| 550 | 0.11 | 0.66 | 0.57 | 0.54 | 0.18 | 0.10 |
| 555 | 0.13 | 0.62 | 0.62 | 0.52 | 0.15 | 0.08 |
| 560 | 0.14 | 0.58 | 0.66 | 0.50 | 0.13 | 0.06 |
| 565 | 0.15 | 0.54 | 0.69 | 0.47 | 0.11 | 0.04 |
| 570 | 0.17 | 0.50 | 0.72 | 0.45 | 0.09 | 0.03 |
| 575 | 0.18 | 0.47 | 0.74 | 0.43 | 0.08 | 0.02 |
| 580 | 0.19 | 0.44 | 0.76 | 0.41 | 0.07 | 0.02 |
| 585 | 0.21 | 0.41 | 0.77 | 0.39 | 0.06 | 0.01 |
| 590 | 0.22 | 0.39 | 0.78 | 0.37 | 0.05 | 0.01 |
| 595 | 0.23 | 0.36 | 0.78 | 0.36 | 0.04 | 0.01 |
| 600 | 0.24 | 0.35 | 0.78 | 0.35 | 0.03 | 0.01 |
| 605 | 0.25 | 0.33 | 0.77 | 0.35 | 0.03 | 0.01 |
| 610 | 0.26 | 0.32 | 0.76 | 0.34 | 0.03 | 0.01 |
| 615 | 0.27 | 0.31 | 0.75 | 0.34 | 0.02 | 0.01 |
| 620 | 0.28 | 0.30 | 0.73 | 0.34 | 0.02 | 0.01 |
| 625 | 0.30 | 0.29 | 0.72 | 0.34 | 0.02 | 0.01 |
| 630 | 0.31 | 0.29 | 0.70 | 0.34 | 0.02 | 0.01 |
| 635 | 0.33 | 0.29 | 0.68 | 0.34 | 0.02 | 0.01 |
| 640 | 0.34 | 0.29 | 0.66 | 0.34 | 0.02 | 0.01 |
| 645 | 0.36 | 0.29 | 0.64 | 0.34 | 0.02 | 0.01 |
| 650 | 0.38 | 0.30 | 0.62 | 0.33 | 0.02 | 0.01 |
| 655 | 0.40 | 0.30 | 0.60 | 0.33 | 0.02 | 0.01 |
| 660 | 0.43 | 0.31 | 0.58 | 0.32 | 0.02 | 0.01 |
| 665 | 0.45 | 0.32 | 0.57 | 0.31 | 0.02 | 0.01 |
| 670 | 0.48 | 0.34 | 0.55 | 0.31 | 0.02 | 0.01 |
| 675 | 0.51 | 0.35 | 0.54 | 0.29 | 0.02 | 0.02 |
| 680 | 0.55 | 0.37 | 0.52 | 0.28 | 0.01 | 0.02 |
| 685 | 0.59 | 0.39 | 0.51 | 0.26 | 0.01 | 0.02 |
| 690 | 0.63 | 0.41 | 0.50 | 0.25 | 0.01 | 0.02 |
| 695 | 0.67 | 0.44 | 0.49 | 0.23 | 0.01 | 0.02 |
| 700 | 0.72 | 0.47 | 0.48 | 0.21 | 0.01 | 0.03 |

### Example 8

A bokeh filter membrane of Example 8 is disposed on a surface of a substrate. The bokeh filter membrane includes a gradient thickness absorbing membrane and an anti-reflection membrane. The gradient thickness absorbing membrane includes a first gradient thickness absorbing membrane and a second gradient thickness absorbing membrane, and the anti-reflection membrane includes a high-and-low refraction membrane and a gradient refraction membrane. The high-and-low refraction membrane includes a first high-and-low refraction membrane and a second high-and-low refraction membrane. The first high-and-low refraction membrane includes an adjacent membrane layer, and the adjacent membrane layer is a layer of the first high-and-low refraction membrane closest to the first gradient thickness absorbing membrane.

The details of each layer of the bokeh filter membrane of Example 8 are shown in Table 9A, wherein “ab1” represents the layer is made of tantalum oxides, and “ab2” represents the layer is made of titanium oxides.

TABLE 9A

| Layer | | Refractive | Physical | Extinction |
|---|---|---|---|---|
| Sequence | Material | index | thickness (nm) | coefficient |
| Substrate | Plastic | 1.52 | — | 0 |
| 1 | Nb₂O₅ | 2.29 | 10.6 | 0 |
| 2 | Al₂O₃ | 1.67 | 32.2 | 0 |
| 3 | Nb₂O₅ | 2.29 | 81.0 | 0 |
| 4 | Al₂O₃ | 1.67 | 4.1 | 0 |
| 5 | ab1 | 2.34 | 0~500 | 0.21 |
| 6 | ab2 | 2.11 | 0~500 | 0.17 |
| 7 | Al₂O₃ | 1.67 | 31.8 | 0 |
| 8 | Nb₂O₅ | 2.29 | 14.2 | 0 |
| 9 | Al₂O₃ | 1.22 | 120.0 | 0 |

Table 9B shows the values of TNG, Nab1, Nab2, Nab1/Narn, Tab1/Tab2, Tar1, Tar2 and TKP of Example 8.

TABLE 9B

| | | | |
|---|---|---|---|
| TNG (nm) | 120.0 | Tab1/Tab2 | 1.0 |
| Nab1 | 2.34 | Tar1 (nm) | 127.8 |
| Nab2 | 2.11 | Tar2 (nm) | 46.0 |
| Nab1/Narn | 1.40 | TKP (nm) | 1293.7 |

Table 9C shows the values of R4070-c, R4050-5, R4555-10, R5570-20, R4070-50 and R4070-p of the bokeh filter membrane of Example 8.

TABLE 9C

| | | | |
|---|---|---|---|
| R4070-c | 0.35 | R5570-20 | 0.81 |
| R4050-5 | 0.37 | R4070-50 | 0.21 |
| R4555-10 | 0.53 | R4070-p | 0.16 |

Table 9D shows the values of reflectance of the bokeh filter membrane of Example 8 in the wavelength range of 400 nm to 700 nm in which the gradient thickness absorbing membrane thereof is with different total membrane thicknesses.

TABLE 9D

| | Total membrane thickness of gradient | | | | | |
|---|---|---|---|---|---|---|
| | thickness absorbing membrane (nm) | | | | | |
| Wavelength | 0 | 50 | 100 | 200 | 500 | 1000 |
| (nm) | Reflectance (%) | | | | | |
| 400 | 1.77 | 1.22 | 1.51 | 1.70 | 0.88 | 1.01 |
| 405 | 1.25 | 1.16 | 1.31 | 1.39 | 0.69 | 0.91 |
| 410 | 0.87 | 1.06 | 1.15 | 1.07 | 0.61 | 0.84 |
| 415 | 0.59 | 0.93 | 1.03 | 0.78 | 0.58 | 0.75 |
| 420 | 0.41 | 0.77 | 0.94 | 0.55 | 0.56 | 0.63 |
| 425 | 0.30 | 0.64 | 0.89 | 0.40 | 0.56 | 0.52 |
| 430 | 0.22 | 0.51 | 0.85 | 0.29 | 0.55 | 0.42 |
| 435 | 0.18 | 0.39 | 0.83 | 0.21 | 0.53 | 0.33 |
| 440 | 0.15 | 0.28 | 0.81 | 0.17 | 0.49 | 0.27 |
| 445 | 0.13 | 0.19 | 0.78 | 0.14 | 0.45 | 0.24 |
| 450 | 0.11 | 0.12 | 0.76 | 0.12 | 0.39 | 0.22 |
| 455 | 0.10 | 0.07 | 0.73 | 0.11 | 0.33 | 0.22 |
| 460 | 0.09 | 0.03 | 0.69 | 0.10 | 0.26 | 0.21 |
| 465 | 0.08 | 0.01 | 0.66 | 0.09 | 0.19 | 0.21 |
| 470 | 0.07 | 0.00 | 0.62 | 0.08 | 0.13 | 0.20 |
| 475 | 0.06 | 0.01 | 0.58 | 0.08 | 0.08 | 0.18 |
| 480 | 0.05 | 0.02 | 0.54 | 0.08 | 0.05 | 0.15 |
| 485 | 0.04 | 0.04 | 0.51 | 0.08 | 0.03 | 0.12 |
| 490 | 0.03 | 0.06 | 0.48 | 0.08 | 0.02 | 0.10 |
| 495 | 0.02 | 0.08 | 0.45 | 0.09 | 0.02 | 0.07 |
| 500 | 0.02 | 0.10 | 0.44 | 0.11 | 0.03 | 0.05 |
| 505 | 0.01 | 0.12 | 0.43 | 0.13 | 0.04 | 0.04 |
| 510 | 0.02 | 0.13 | 0.42 | 0.15 | 0.05 | 0.04 |
| 515 | 0.02 | 0.14 | 0.43 | 0.18 | 0.06 | 0.04 |
| 520 | 0.02 | 0.15 | 0.43 | 0.21 | 0.07 | 0.04 |
| 525 | 0.03 | 0.16 | 0.45 | 0.24 | 0.08 | 0.05 |
| 530 | 0.04 | 0.15 | 0.46 | 0.27 | 0.08 | 0.05 |
| 535 | 0.06 | 0.14 | 0.48 | 0.29 | 0.07 | 0.05 |
| 540 | 0.08 | 0.13 | 0.50 | 0.32 | 0.07 | 0.06 |
| 545 | 0.09 | 0.12 | 0.51 | 0.35 | 0.07 | 0.06 |
| 550 | 0.11 | 0.11 | 0.52 | 0.38 | 0.07 | 0.06 |
| 555 | 0.13 | 0.10 | 0.53 | 0.42 | 0.07 | 0.06 |
| 560 | 0.15 | 0.08 | 0.53 | 0.45 | 0.07 | 0.06 |
| 565 | 0.17 | 0.07 | 0.53 | 0.49 | 0.07 | 0.06 |
| 570 | 0.19 | 0.06 | 0.53 | 0.53 | 0.07 | 0.06 |
| 575 | 0.21 | 0.05 | 0.52 | 0.57 | 0.08 | 0.06 |
| 580 | 0.23 | 0.04 | 0.51 | 0.61 | 0.09 | 0.06 |
| 585 | 0.25 | 0.04 | 0.49 | 0.66 | 0.10 | 0.06 |
| 590 | 0.27 | 0.03 | 0.47 | 0.70 | 0.11 | 0.06 |
| 595 | 0.29 | 0.03 | 0.45 | 0.75 | 0.12 | 0.06 |
| 600 | 0.31 | 0.02 | 0.43 | 0.79 | 0.14 | 0.06 |
| 605 | 0.33 | 0.02 | 0.40 | 0.83 | 0.15 | 0.05 |
| 610 | 0.35 | 0.02 | 0.37 | 0.87 | 0.17 | 0.05 |
| 615 | 0.37 | 0.02 | 0.35 | 0.91 | 0.18 | 0.04 |
| 620 | 0.39 | 0.02 | 0.32 | 0.94 | 0.20 | 0.04 |
| 625 | 0.42 | 0.01 | 0.29 | 0.97 | 0.21 | 0.04 |
| 630 | 0.44 | 0.01 | 0.27 | 0.99 | 0.22 | 0.03 |
| 635 | 0.46 | 0.01 | 0.24 | 1.01 | 0.22 | 0.03 |
| 640 | 0.49 | 0.01 | 0.22 | 1.02 | 0.23 | 0.03 |
| 645 | 0.51 | 0.01 | 0.20 | 1.03 | 0.23 | 0.03 |
| 650 | 0.54 | 0.01 | 0.18 | 1.03 | 0.22 | 0.03 |
| 655 | 0.58 | 0.01 | 0.16 | 1.03 | 0.22 | 0.03 |
| 660 | 0.61 | 0.01 | 0.15 | 1.02 | 0.21 | 0.03 |
| 665 | 0.65 | 0.01 | 0.13 | 1.00 | 0.20 | 0.03 |
| 670 | 0.69 | 0.01 | 0.12 | 0.98 | 0.18 | 0.04 |
| 675 | 0.73 | 0.01 | 0.12 | 0.95 | 0.16 | 0.04 |
| 680 | 0.77 | 0.01 | 0.11 | 0.92 | 0.14 | 0.04 |
| 685 | 0.82 | 0.01 | 0.11 | 0.88 | 0.12 | 0.04 |
| 690 | 0.88 | 0.01 | 0.10 | 0.83 | 0.10 | 0.04 |
| 695 | 0.94 | 0.01 | 0.10 | 0.79 | 0.08 | 0.04 |
| 700 | 1.00 | 0.01 | 0.11 | 0.74 | 0.07 | 0.04 |

### Example 9

A bokeh filter membrane of Example 9 is disposed on a surface of a substrate. The bokeh filter membrane includes a gradient thickness absorbing membrane and an anti-reflection membrane. The gradient thickness absorbing membrane includes a first gradient thickness absorbing membrane and a second gradient thickness absorbing membrane, and the anti-reflection membrane includes a high-and-low refraction membrane and a gradient refraction membrane. The high-and-low refraction membrane includes a first high-and-low refraction membrane and a second high-and-low refraction membrane. The first high-and-low refraction membrane includes an adjacent membrane layer, and the adjacent membrane layer is a layer of the first high-and-low refraction membrane closest to the first gradient thickness absorbing membrane.

The details of each layer of the bokeh filter membrane of Example 9 are shown in Table 10A, wherein “ab1” represents the layer is made of tantalum oxides, and “ab2” represents the layer is made of titanium oxides.

TABLE 10A

| Layer | | Refractive | Physical | Extinction |
|---|---|---|---|---|
| Sequence | Material | index | thickness (nm) | coefficient |
| Substrate | Glass | 1.52 | — | 0 |
| 1 | Ta₂O₅ | 2.14 | 15.0 | 0 |
| 2 | Al₂O₃ | 1.67 | 34.0 | 0 |
| 3 | Ta₂O₅ | 2.14 | 70.0 | 0 |
| 4 | Al₂O₃ | 1.67 | 10.0 | 0 |
| 5 | ab1 | 2.34 | 0~500 | 0.21 |
| 6 | ab2 | 2.11 | 0~500 | 0.17 |
| 7 | Al₂O₃ | 1.67 | 28.0 | 0 |
| 8 | Ta₂O₅ | 2.14 | 16.5 | 0 |
| 9 | Al₂O₃ | 1.22 | 240.0 | 0 |

Table 10B shows the values of TNG, Nab1, Nab2, Nab1/Narn, Tab1/Tab2, Tar1, Tar2 and TKP of Example 9.

TABLE 10B

| | | | |
|---|---|---|---|
| TNG (nm) | 240.0 | Tab1/Tab2 | 1.0 |
| Nab1 | 2.34 | Tar1 (nm) | 129.0 |
| Nab2 | 2.11 | Tar2 (nm) | 44.5 |
| Nab1/Narn | 1.40 | TKP (nm) | 1413.5 |

Table 10C shows the values of R4070-c, R4050-5, R4555-10, R5570-20, R4070-50 and R4070-p of the bokeh filter membrane of Example 9.

TABLE 10C

| | | | |
|---|---|---|---|
| R4070-c | 0.37 | R5570-20 | 0.69 |
| R4050-5 | 0.20 | R4070-50 | 0.22 |
| R4555-10 | 0.70 | R4070-p | 0.21 |

Table 10D shows the values of reflectance of the bokeh filter membrane of Example 9 in the wavelength range of 400 nm to 700 nm in which the gradient thickness absorbing membrane thereof is with different total membrane thicknesses.

TABLE 10D

| Total membrane | | | | | | |
|---|---|---|---|---|---|---|
| thickness of | | | | | | |
| gradient thickness | | | | | | |
| absorbing | | | | | | |
| membrane (nm) | 0 | 50 | 100 | 200 | 500 | 1000 |
| Wavelength (nm) | Reflectance (%) | | | | | |
| 400 | 1.33 | 0.44 | 0.51 | 0.79 | 0.16 | 0.20 |
| 405 | 0.97 | 0.47 | 0.43 | 0.69 | 0.12 | 0.20 |
| 410 | 0.69 | 0.48 | 0.37 | 0.56 | 0.12 | 0.22 |
| 415 | 0.48 | 0.47 | 0.33 | 0.43 | 0.14 | 0.24 |
| 420 | 0.32 | 0.43 | 0.33 | 0.32 | 0.17 | 0.24 |
| 425 | 0.22 | 0.39 | 0.36 | 0.22 | 0.20 | 0.22 |
| 430 | 0.16 | 0.33 | 0.42 | 0.15 | 0.23 | 0.19 |
| 435 | 0.12 | 0.27 | 0.49 | 0.11 | 0.26 | 0.16 |
| 440 | 0.12 | 0.20 | 0.57 | 0.09 | 0.29 | 0.14 |
| 445 | 0.13 | 0.14 | 0.65 | 0.08 | 0.31 | 0.13 |
| 450 | 0.15 | 0.08 | 0.73 | 0.08 | 0.31 | 0.14 |
| 455 | 0.18 | 0.05 | 0.81 | 0.09 | 0.31 | 0.17 |
| 460 | 0.20 | 0.03 | 0.87 | 0.10 | 0.29 | 0.20 |
| 465 | 0.22 | 0.01 | 0.91 | 0.11 | 0.26 | 0.23 |
| 470 | 0.24 | 0.00 | 0.95 | 0.12 | 0.22 | 0.26 |
| 475 | 0.26 | 0.00 | 0.97 | 0.13 | 0.18 | 0.27 |
| 480 | 0.27 | 0.01 | 0.97 | 0.13 | 0.14 | 0.28 |
| 485 | 0.28 | 0.03 | 0.95 | 0.14 | 0.11 | 0.27 |
| 490 | 0.28 | 0.05 | 0.92 | 0.15 | 0.09 | 0.26 |
| 495 | 0.27 | 0.09 | 0.88 | 0.16 | 0.10 | 0.24 |
| 500 | 0.26 | 0.12 | 0.83 | 0.18 | 0.12 | 0.22 |
| 505 | 0.25 | 0.17 | 0.77 | 0.21 | 0.15 | 0.21 |
| 510 | 0.23 | 0.21 | 0.71 | 0.25 | 0.20 | 0.21 |
| 515 | 0.21 | 0.26 | 0.64 | 0.30 | 0.25 | 0.23 |
| 520 | 0.19 | 0.31 | 0.57 | 0.36 | 0.30 | 0.25 |
| 525 | 0.16 | 0.36 | 0.51 | 0.43 | 0.34 | 0.28 |
| 530 | 0.14 | 0.40 | 0.45 | 0.50 | 0.37 | 0.31 |
| 535 | 0.11 | 0.44 | 0.39 | 0.58 | 0.40 | 0.33 |
| 540 | 0.09 | 0.48 | 0.34 | 0.66 | 0.41 | 0.35 |
| 545 | 0.07 | 0.52 | 0.30 | 0.73 | 0.42 | 0.35 |
| 550 | 0.05 | 0.55 | 0.27 | 0.81 | 0.42 | 0.35 |
| 555 | 0.04 | 0.57 | 0.24 | 0.88 | 0.42 | 0.33 |
| 560 | 0.03 | 0.59 | 0.23 | 0.94 | 0.41 | 0.31 |
| 565 | 0.03 | 0.60 | 0.22 | 0.99 | 0.40 | 0.28 |
| 570 | 0.02 | 0.61 | 0.22 | 1.04 | 0.39 | 0.26 |
| 575 | 0.03 | 0.62 | 0.23 | 1.07 | 0.38 | 0.23 |
| 580 | 0.04 | 0.62 | 0.25 | 1.09 | 0.37 | 0.21 |
| 585 | 0.05 | 0.62 | 0.27 | 1.10 | 0.36 | 0.19 |
| 590 | 0.07 | 0.61 | 0.30 | 1.09 | 0.35 | 0.17 |
| 595 | 0.09 | 0.60 | 0.33 | 1.08 | 0.33 | 0.15 |
| 600 | 0.12 | 0.59 | 0.36 | 1.05 | 0.32 | 0.14 |
| 605 | 0.16 | 0.58 | 0.40 | 1.02 | 0.30 | 0.13 |
| 610 | 0.19 | 0.56 | 0.44 | 0.98 | 0.28 | 0.12 |
| 615 | 0.23 | 0.55 | 0.48 | 0.93 | 0.26 | 0.12 |
| 620 | 0.28 | 0.53 | 0.53 | 0.87 | 0.23 | 0.12 |
| 625 | 0.33 | 0.52 | 0.57 | 0.82 | 0.21 | 0.12 |
| 630 | 0.38 | 0.51 | 0.61 | 0.75 | 0.18 | 0.12 |
| 635 | 0.44 | 0.50 | 0.65 | 0.69 | 0.15 | 0.13 |
| 640 | 0.49 | 0.49 | 0.69 | 0.63 | 0.13 | 0.14 |
| 645 | 0.55 | 0.48 | 0.73 | 0.56 | 0.10 | 0.14 |
| 650 | 0.62 | 0.47 | 0.76 | 0.50 | 0.08 | 0.15 |
| 655 | 0.68 | 0.47 | 0.80 | 0.44 | 0.06 | 0.16 |
| 660 | 0.74 | 0.47 | 0.83 | 0.39 | 0.04 | 0.16 |
| 665 | 0.80 | 0.47 | 0.86 | 0.33 | 0.03 | 0.17 |
| 670 | 0.87 | 0.47 | 0.89 | 0.28 | 0.02 | 0.18 |
| 675 | 0.93 | 0.48 | 0.91 | 0.24 | 0.02 | 0.18 |
| 680 | 1.00 | 0.49 | 0.94 | 0.20 | 0.02 | 0.18 |
| 685 | 1.06 | 0.50 | 0.96 | 0.16 | 0.03 | 0.19 |
| 690 | 1.13 | 0.52 | 0.98 | 0.13 | 0.04 | 0.19 |
| 695 | 1.19 | 0.54 | 1.00 | 0.10 | 0.06 | 0.20 |
| 700 | 1.26 | 0.56 | 1.02 | 0.08 | 0.07 | 0.21 |

### Example 10

A bokeh filter membrane of Example 10 is disposed on a surface of a substrate. The bokeh filter membrane includes a gradient thickness absorbing membrane and an anti-reflection membrane. The gradient thickness absorbing membrane includes a first gradient thickness absorbing membrane and a second gradient thickness absorbing membrane, and the anti-reflection membrane includes a high-and-low refraction membrane and a gradient refraction membrane. The high-and-low refraction membrane includes a first high-and-low refraction membrane and a second high-and-low refraction membrane. The first high-and-low refraction membrane includes an adjacent membrane layer, and the adjacent membrane layer is a layer of the first high-and-low refraction membrane closest to the first gradient thickness absorbing membrane.

The details of each layer of the bokeh filter membrane of Example 10 are shown in Table 11A, wherein “ab1” represents the layer is made of tantalum oxides, and “ab2” represents the layer is made of titanium oxides.

TABLE 11A

| Layer | | Refractive | Physical | Extinction |
|---|---|---|---|---|
| Sequence | Material | index | thickness (nm) | coefficient |
| Substrate | Glass | 1.52 | — | 0 |
| 1 | ZrO₂ | 2.07 | 20.0 | 4.0E−05 |
| 2 | SiO₂ | 1.46 | 30.0 | 0 |
| 3 | ZrO₂ | 2.07 | 75.0 | 4.0E−05 |
| 4 | SiO₂ | 1.46 | 9.0 | 0 |
| 5 | ab1 | 2.34 | 0~500 | 0.21 |
| 6 | ab2 | 2.11 | 0~500 | 0.17 |
| 7 | SiO₂ | 1.46 | 16.0 | 0 |
| 8 | ZrO₂ | 2.07 | 27.0 | 4.0E−05 |
| 9 | Al₂O₃ | 1.22 | 240.0 | 0 |

Table 11B shows the values of TNG, Nab1, Nab2, Nab1/Narn, Tab1/Tab2, Tar1, Tar2 and TKP of Example 10.

TABLE 11B

| | | | |
|---|---|---|---|
| TNG (nm) | 240.0 | Tab1/Tab2 | 1.0 |
| Nab1 | 2.34 | Tar1 (nm) | 134.0 |
| Nab2 | 2.11 | Tar2 (nm) | 43.0 |
| Nab1/Narn | 1.60 | TKP (nm) | 1417.0 |

Table 11C shows the values of R4070-c, R4050-5, R4555-10, R5570-20, R4070-50 and R4070-p of the bokeh filter membrane of Example 10.

TABLE 11C

| | | | |
|---|---|---|---|
| R4070-c | 0.41 | R5570-20 | 0.57 |
| R4050-5 | 0.48 | R4070-50 | 0.30 |
| R4555-10 | 0.68 | R4070-p | 0.29 |

Table 11D shows the values of reflectance of the bokeh filter membrane of Example 10 in the wavelength range of 400 nm to 700 nm in which the gradient thickness absorbing membrane thereof is with different total membrane thicknesses.

TABLE 11D

| Total membrane | | | | | | |
|---|---|---|---|---|---|---|
| thickness of | | | | | | |
| gradient thickness | | | | | | |
| absorbing | | | | | | |
| membrane (nm) | 0 | 50 | 100 | 200 | 500 | 1000 |
| Wavelength (nm) | Reflectance (%) | | | | | |
| 400 | 2.06 | 0.89 | 1.17 | 1.33 | 0.25 | 0.38 |
| 405 | 1.60 | 0.92 | 1.01 | 1.19 | 0.24 | 0.41 |
| 410 | 1.23 | 0.93 | 0.88 | 1.02 | 0.28 | 0.44 |
| 415 | 0.93 | 0.92 | 0.77 | 0.83 | 0.35 | 0.46 |
| 420 | 0.69 | 0.89 | 0.69 | 0.65 | 0.41 | 0.46 |
| 425 | 0.50 | 0.85 | 0.64 | 0.50 | 0.47 | 0.43 |
| 430 | 0.36 | 0.78 | 0.62 | 0.37 | 0.51 | 0.40 |
| 435 | 0.25 | 0.71 | 0.62 | 0.27 | 0.53 | 0.36 |
| 440 | 0.18 | 0.63 | 0.65 | 0.20 | 0.54 | 0.33 |
| 445 | 0.13 | 0.55 | 0.68 | 0.16 | 0.54 | 0.31 |
| 450 | 0.11 | 0.46 | 0.73 | 0.14 | 0.53 | 0.32 |
| 455 | 0.10 | 0.38 | 0.78 | 0.13 | 0.51 | 0.34 |
| 460 | 0.10 | 0.31 | 0.82 | 0.14 | 0.48 | 0.38 |
| 465 | 0.11 | 0.24 | 0.86 | 0.16 | 0.43 | 0.41 |
| 470 | 0.12 | 0.18 | 0.89 | 0.18 | 0.38 | 0.43 |
| 475 | 0.14 | 0.13 | 0.91 | 0.21 | 0.32 | 0.44 |
| 480 | 0.16 | 0.10 | 0.92 | 0.23 | 0.27 | 0.44 |
| 485 | 0.17 | 0.07 | 0.91 | 0.26 | 0.23 | 0.42 |
| 490 | 0.19 | 0.06 | 0.89 | 0.29 | 0.20 | 0.39 |
| 495 | 0.20 | 0.06 | 0.86 | 0.32 | 0.19 | 0.36 |
| 500 | 0.21 | 0.06 | 0.82 | 0.35 | 0.19 | 0.33 |
| 505 | 0.22 | 0.08 | 0.77 | 0.39 | 0.22 | 0.31 |
| 510 | 0.22 | 0.10 | 0.71 | 0.42 | 0.25 | 0.30 |
| 515 | 0.22 | 0.13 | 0.64 | 0.46 | 0.29 | 0.31 |
| 520 | 0.22 | 0.16 | 0.58 | 0.51 | 0.34 | 0.32 |
| 525 | 0.21 | 0.20 | 0.51 | 0.56 | 0.39 | 0.35 |
| 530 | 0.21 | 0.24 | 0.45 | 0.61 | 0.43 | 0.38 |
| 535 | 0.20 | 0.28 | 0.39 | 0.66 | 0.46 | 0.40 |
| 540 | 0.20 | 0.32 | 0.33 | 0.71 | 0.48 | 0.41 |
| 545 | 0.19 | 0.36 | 0.29 | 0.76 | 0.50 | 0.41 |
| 550 | 0.19 | 0.40 | 0.25 | 0.81 | 0.50 | 0.40 |
| 555 | 0.18 | 0.44 | 0.22 | 0.85 | 0.50 | 0.38 |
| 560 | 0.18 | 0.48 | 0.19 | 0.88 | 0.49 | 0.35 |
| 565 | 0.18 | 0.51 | 0.18 | 0.91 | 0.47 | 0.32 |
| 570 | 0.18 | 0.55 | 0.17 | 0.93 | 0.46 | 0.29 |
| 575 | 0.19 | 0.58 | 0.17 | 0.94 | 0.44 | 0.26 |
| 580 | 0.20 | 0.61 | 0.18 | 0.94 | 0.41 | 0.23 |
| 585 | 0.21 | 0.63 | 0.20 | 0.94 | 0.39 | 0.21 |
| 590 | 0.22 | 0.66 | 0.22 | 0.92 | 0.37 | 0.19 |
| 595 | 0.23 | 0.68 | 0.25 | 0.90 | 0.34 | 0.17 |
| 600 | 0.25 | 0.70 | 0.28 | 0.87 | 0.32 | 0.15 |
| 605 | 0.27 | 0.72 | 0.32 | 0.83 | 0.29 | 0.14 |
| 610 | 0.29 | 0.74 | 0.36 | 0.79 | 0.27 | 0.14 |
| 615 | 0.32 | 0.76 | 0.40 | 0.75 | 0.24 | 0.13 |
| 620 | 0.35 | 0.78 | 0.45 | 0.70 | 0.22 | 0.13 |
| 625 | 0.38 | 0.80 | 0.50 | 0.64 | 0.19 | 0.13 |
| 630 | 0.41 | 0.82 | 0.55 | 0.59 | 0.16 | 0.14 |
| 635 | 0.44 | 0.85 | 0.60 | 0.54 | 0.14 | 0.14 |
| 640 | 0.47 | 0.87 | 0.65 | 0.48 | 0.12 | 0.15 |
| 645 | 0.51 | 0.89 | 0.70 | 0.43 | 0.10 | 0.16 |
| 650 | 0.54 | 0.91 | 0.75 | 0.38 | 0.08 | 0.17 |
| 655 | 0.58 | 0.94 | 0.80 | 0.33 | 0.07 | 0.18 |
| 660 | 0.62 | 0.96 | 0.85 | 0.28 | 0.05 | 0.18 |
| 665 | 0.65 | 0.99 | 0.90 | 0.24 | 0.05 | 0.19 |
| 670 | 0.69 | 1.02 | 0.95 | 0.20 | 0.04 | 0.20 |
| 675 | 0.73 | 1.05 | 1.00 | 0.16 | 0.04 | 0.20 |
| 680 | 0.77 | 1.08 | 1.05 | 0.12 | 0.05 | 0.21 |
| 685 | 0.81 | 1.12 | 1.09 | 0.10 | 0.06 | 0.22 |
| 690 | 0.85 | 1.15 | 1.14 | 0.07 | 0.07 | 0.22 |
| 695 | 0.88 | 1.19 | 1.18 | 0.05 | 0.08 | 0.23 |
| 700 | 0.92 | 1.22 | 1.22 | 0.03 | 0.10 | 0.24 |

### Example 11

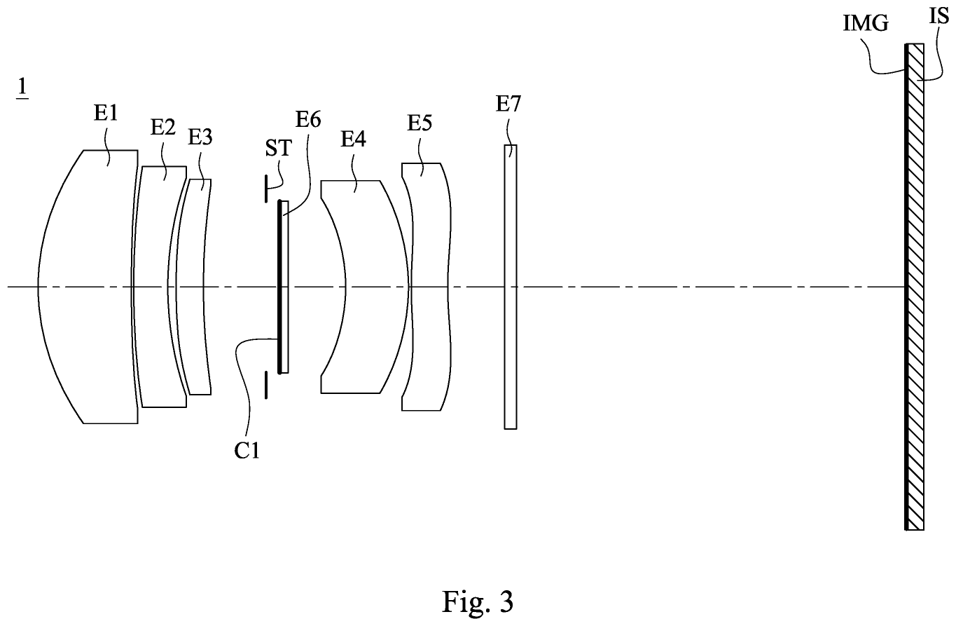

FIG. 3 is a schematic view of an imaging optical lens assembly 1 according to Example 11 of the present disclosure. The imaging optical lens assembly 1 includes, in order from an object side to an image side along an optical path, a first optical lens element E1, a second optical lens element E2, a third optical lens element E3, an aperture stop ST, a first filter E6, a fourth optical lens element E4, a fifth optical lens element E5, a second filter E7 and an image surface IMG, and the image sensor IS is disposed on the image surface IMG of the imaging optical lens assembly 1.

The first optical lens element E1, the second optical lens element E2, the third optical lens element E3, the fourth optical lens element E4 and the fifth optical lens element E5 respectively have an object-side surface and an image-side surface, wherein the aperture stop ST is located between the third optical lens element E3 and the fourth optical lens element E4, the first filter E6 is located between the aperture stop ST and the fourth optical lens element E4, and the object-side surface of the first filter E6 includes a bokeh filter membrane C1. The bokeh filter membrane C1 can be any of the bokeh filter membrane according to Example 1 to Example 10, and the same structures or the details thereof will not be described herein.

### Example 12

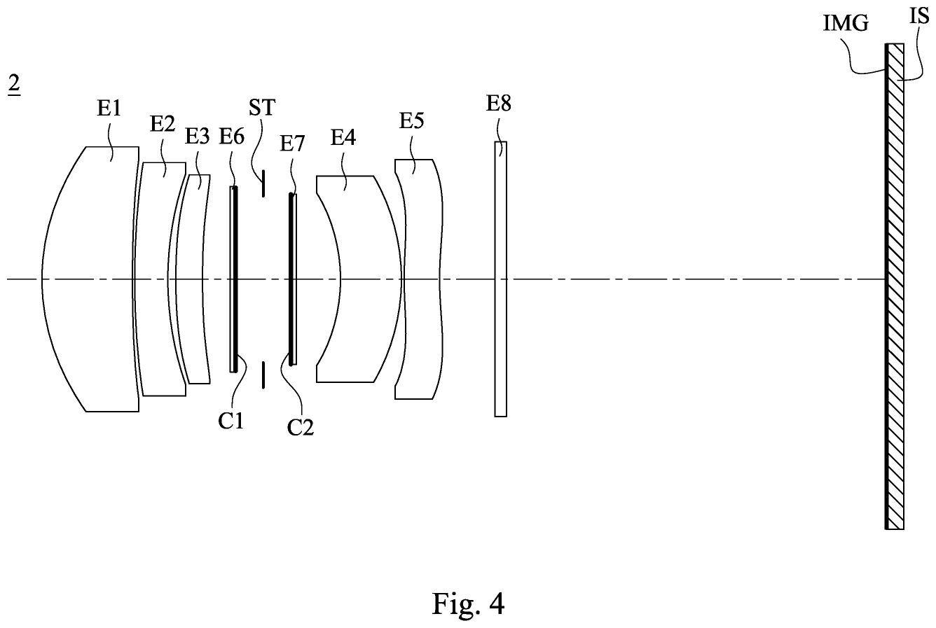

FIG. 4 is a schematic view of an imaging optical lens assembly 2 according to Example 12 of the present disclosure. The imaging optical lens assembly 2 includes, in order from an object side to an image side along an optical path, a first optical lens element E1, a second optical lens element E2, a third optical lens element E3, a first filter E6, an aperture stop ST, a second filter E7, a fourth optical lens element E4, a fifth optical lens element E5, a third filter E8 and an image surface IMG, and the image sensor IS is disposed on the image surface IMG of the imaging optical lens assembly 2.

The first optical lens element E1, the second optical lens element E2, the third optical lens element E3, the fourth optical lens element E4 and the fifth optical lens element E5 respectively have an object-side surface and an image-side surface, wherein the aperture stop ST is located between the third optical lens element E3 and the fourth optical lens element E4. The image-side surface of the first filter E6 includes the bokeh filter membrane C1, the object-side surface of the second filter E7 includes the bokeh filter membrane C2, wherein a distance along the optical axis between the image-side surface of the first filter E6 and the aperture stop ST is equal to a distance along the optical axis between the aperture stop ST and the object-side surface of the second filter E7. The bokeh filter membrane C1 and the bokeh filter membrane C2 can be any of the bokeh filter membrane according to Example 1 to Example 10, and the same structures or the details thereof will not be described herein.

### Example 13

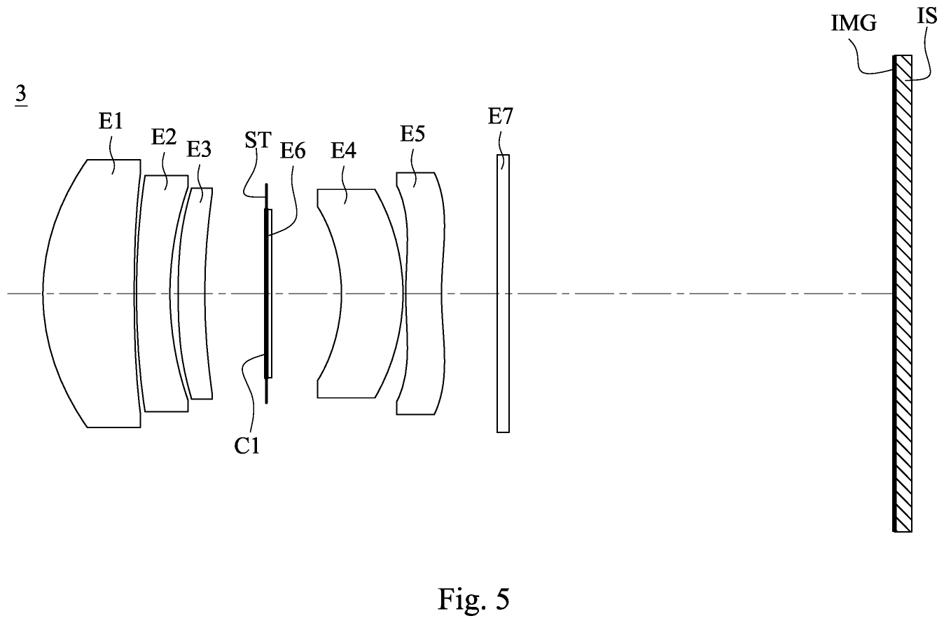

FIG. 5 is a schematic view of an imaging optical lens assembly 3 according to Example 13 of the present disclosure. The imaging optical lens assembly 3 includes, in order from an object side to an image side along an optical path, a first optical lens element E1, a second optical lens element E2, a third optical lens element E3, an aperture stop ST, a first filter E6, a fourth optical lens element E4, a fifth optical lens element E5, a second filter E7 and an image surface IMG, and the image sensor IS is disposed on the image surface IMG of the imaging optical lens assembly 3.

The first optical lens element E1, the second optical lens element E2, the third optical lens element E3, the fourth optical lens element E4 and the fifth optical lens element E5 respectively have an object-side surface and an image-side surface, wherein the aperture stop ST is located between the third optical lens element E3 and the fourth optical lens element E4. The object-side surface of the first filter E6 includes a bokeh filter membrane C1, and the object-side surface of the first filter E6 is located at the same position of the optical axis as the aperture stop ST. The bokeh filter membrane C1 can be any of the bokeh filter membrane according to Example 1 to Example 10, and the same structures or the details thereof will not be described herein.

### Example 14

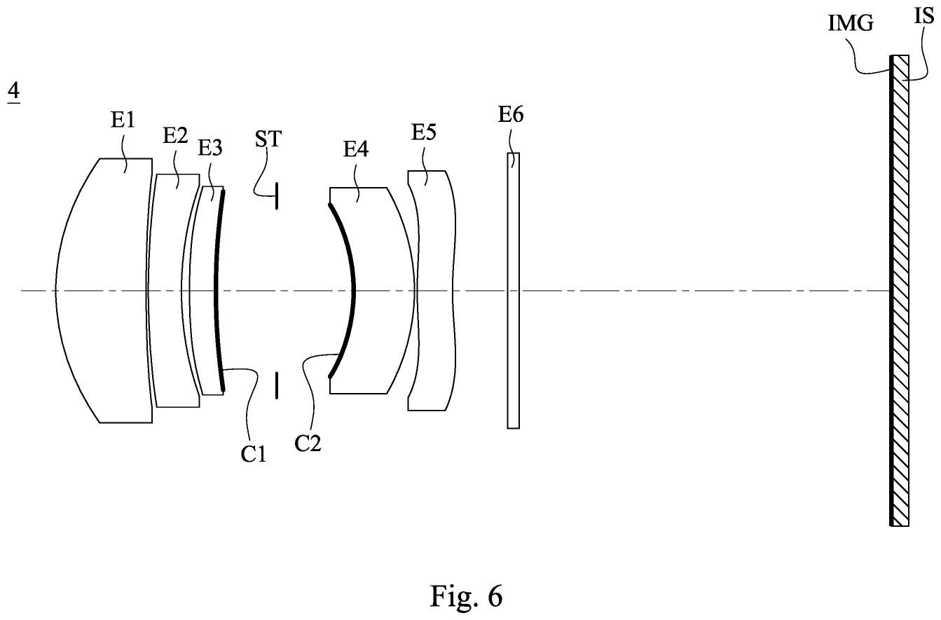

FIG. 6 is a schematic view of an imaging optical lens assembly 4 according to Example 14 of the present disclosure. The imaging optical lens assembly 4 includes, in order from an object side to an image side along an optical path, a first optical lens element E1, a second optical lens element E2, a third optical lens element E3, an aperture stop ST, a fourth optical lens element E4, a fifth optical lens element E5, a first filter E6 and an image surface IMG, and the image sensor IS is disposed on the image surface IMG of the imaging optical lens assembly 4.

The first optical lens element E1, the second optical lens element E2, the third optical lens element E3, the fourth optical lens element E4 and the fifth optical lens element E5 respectively have an object-side surface and an image-side surface, wherein the aperture stop ST is located between the third optical lens element E3 and the fourth optical lens element E4. The image-side surface of the third optical lens element E3 includes a bokeh filter membrane C1, and the object-side surface of the fourth optical lens element E4 includes a bokeh filter membrane C2. The bokeh filter membrane C1 and the bokeh filter membrane C2 can be any of the bokeh filter membrane according to Example 1 to Example 10, and the same structures or the details thereof will not be described herein.

### Example 15

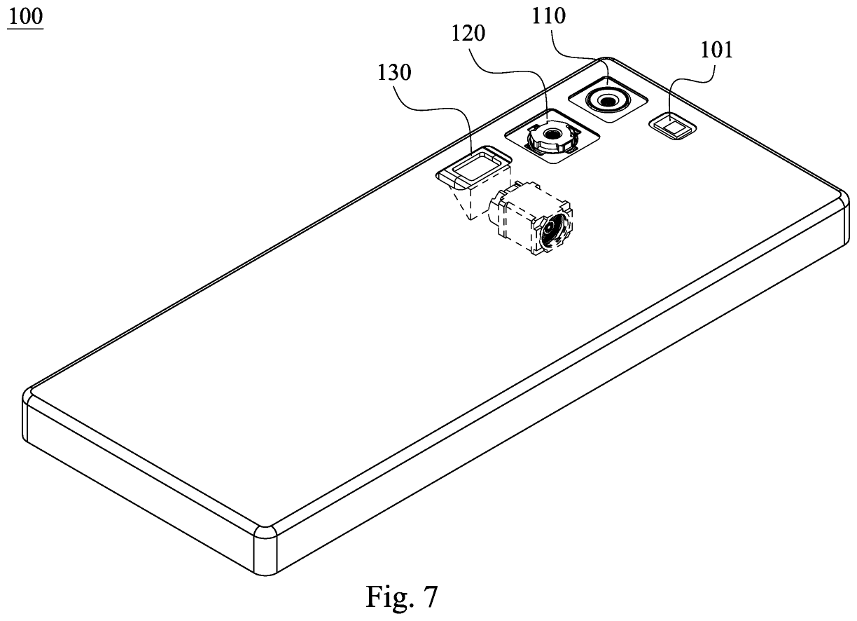

FIG. 7 is a schematic view of an electronic device 100 according to Example 15 of the present disclosure. The electronic device 100 of Example 15 is a smartphone and includes imaging apparatuses 110, 120, 130 and a flash module 101.

The imaging apparatuses 110, 120, 130 of the electronic device 100 of Example 15 can include an imaging optical lens assembly of the present disclosure, and the imaging optical lens assembly can have a configuration which is the same or similar to that according to the imaging optical lens assemblies 1, 2, 3, 4 of Example 11 to Example 14, so that the details will not be described again herein.

In detail, the imaging apparatus 110 can be an ultra-wide angle imaging apparatus, the imaging apparatus 120 can be a wide angle imaging apparatus, the imaging apparatus 130 can be telephoto imaging apparatus (which can include light path folding elements), or can be adaptively adjusted according to the type of the imaging apparatuses, and the present disclosure will not be limited to the aforementioned arrangement.

### Example 16

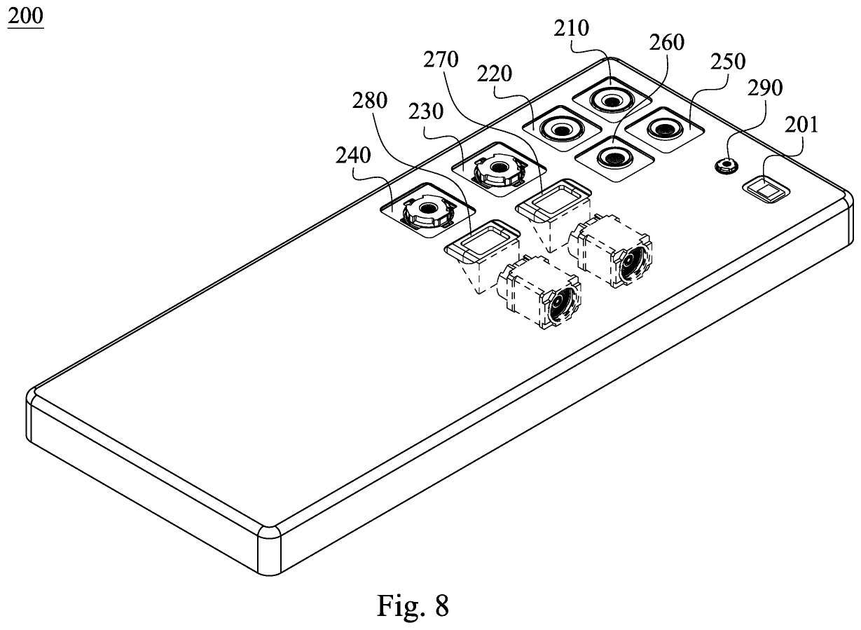

FIG. 8 is a schematic view of an electronic device 200 according to Example 16 of the present disclosure. As shown in FIG. 8, the electronic device 200 of Example 16 is a smartphone, and the electronic device 200 includes imaging apparatuses 210, 220, 230, 240, 250, 260, 270, 280, 290 and a flash module 201.

Each of the imaging apparatuses 210, 220, 230, 240, 250, 260, 270, 280, 290 of the electronic device 200 of Example 16 can include an imaging optical lens assembly of the present disclosure, and the imaging optical lens assembly can have a configuration which is the same or similar to that according to the imaging optical lens assemblies 1, 2, 3, 4 of Example 11 to Example 14, so that the details will not be described again herein.

In detail, the imaging apparatuses 210, 220 can respectively be an ultra-wide angle imaging apparatus, the imaging apparatuses 230, 240 can respectively be a wide angle imaging apparatus, the imaging apparatuses 250, 260 can respectively be a telephoto imaging apparatus, the imaging apparatuses 270, 280 can respectively be a telephoto imaging apparatus (which can include light path folding elements), the imaging apparatus 290 can be a TOF module, or can be adaptively adjusted according to the type of the imaging apparatuses, and the present disclosure will not be limited to the aforementioned arrangement.

### Example 17

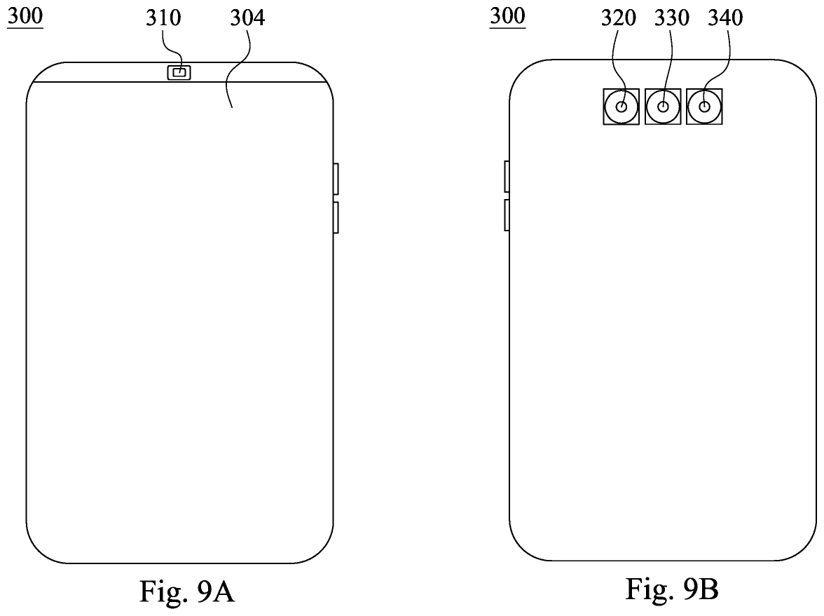

FIG. 9A is a schematic view of one side of an electronic device 300 according to Example 17 of the present disclosure, and FIG. 9B is a schematic view of another side of the electronic device 300 of FIG. 9A. As shown in FIG. 9A and FIG. 9B, the electronic device 300 of Example 17 is a smartphone, and the electronic device 300 includes imaging apparatuses 310, 320, 330, 340 and a user interface 304.

The imaging apparatuses 310, 320, 330, 340 of the electronic device 300 of Example 17 can include an imaging optical lens assembly of the present disclosure, and the imaging optical lens assembly can have a configuration which is the same or similar to that according to the imaging optical lens assemblies 1, 2, 3, 4 of Example 11 to Example 14, so that the details will not be described again herein.

In detail, the imaging apparatus 310 corresponds to a non-circular opening located on an outer side of the electronic device 30 for capturing the image. The imaging apparatuses 320, 330, 340 can respectively be a telephoto imaging apparatus, a wide angle imaging apparatus and an ultra-wide angle imaging apparatus, or can be adaptively adjusted according to the type of the imaging apparatuses, and the present disclosure will not be limited to the aforementioned arrangement.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A bokeh filter membrane, which is disposed on a surface of a substrate, comprising:
a gradient thickness absorbing membrane; and
an anti-reflection membrane comprising a high-and-low refraction membrane and a gradient refraction membrane;
wherein a transmittance of the substrate at a center thereof is greater than a transmittance of the substrate at a peripheral region thereof;
wherein the high-and-low refraction membrane comprises a first high-and-low refraction membrane and a second high-and-low refraction membrane, the gradient thickness absorbing membrane is farther away from the substrate than the first high-and-low refraction membrane, the second high-and-low refraction membrane is farther away from the substrate than the gradient thickness absorbing membrane, and the gradient refraction membrane is farther away from the substrate than the second high-and-low refraction membrane;
wherein the gradient refraction membrane comprises a plurality of pores, and the pores away from the substrate are relatively larger than the pores close to the substrate;
wherein a main material of the gradient refraction membrane is metal oxide;
wherein a membrane thickness of the gradient refraction membrane is TNG, and the following condition is satisfied:
115.0 nm≤TNG≤1000.0 nm.

2. The bokeh filter membrane of claim 1, wherein the membrane thickness of the gradient refraction membrane is TNG, and the following condition is satisfied:
118.0 nm≤TNG≤350.0 nm.

3. The bokeh filter membrane of claim 1, wherein the gradient thickness absorbing membrane comprises a first gradient thickness absorbing membrane and a second gradient thickness absorbing membrane, the second gradient thickness absorbing membrane is farther away from the substrate than the first gradient thickness absorbing membrane, a refractive index of the first gradient thickness absorbing membrane is Nab1, a refractive index of the second gradient thickness absorbing membrane is Nab2, and the following condition is satisfied:
Nab1>Nab2.

4. The bokeh filter membrane of claim 3, wherein the first high-and-low refraction membrane comprises an adjacent membrane layer, the adjacent membrane layer is a layer of the first high-and-low refraction membrane closest to the first gradient thickness absorbing membrane, the refractive index of the first gradient thickness absorbing membrane is Nab1, a refractive index of the adjacent membrane layer is Narn, the following condition is satisfied:
1.32≤Nab1/Narn≤2.00.

5. The bokeh filter membrane of claim 1, wherein the gradient thickness absorbing membrane comprises a first gradient thickness absorbing membrane and a second gradient thickness absorbing membrane, the second gradient thickness absorbing membrane is farther away from the substrate than the first gradient thickness absorbing membrane, a membrane thickness of the first gradient thickness absorbing membrane at a maximum effective diameter is Tab1, a membrane thickness of the second gradient thickness absorbing membrane at the maximum effective diameter is Tab2, and the following condition is satisfied:
0.60≤Tab1/Tab2≤1.80.

6. The bokeh filter membrane of claim 5, wherein a total membrane thickness of the first high-and-low refraction membrane is Tar1, and the following condition is satisfied:
105.0 nm≤Tar1≤200.0 nm.

7. The bokeh filter membrane of claim 5, wherein a total membrane thickness of the second high-and-low refraction membrane is Tar2, and the following condition is satisfied:
38.0 nm≤Tar2≤150.0 nm.

8. The bokeh filter membrane of claim 1, wherein an average reflectance in a wavelength range of 400 nm-700 nm of the bokeh filter membrane at the center of the substrate is R4070-c, and the following condition is satisfied:
0%≤R4070-c≤3.00%.

9. The bokeh filter membrane of claim 1, wherein an average reflectance in a wavelength range of 400 nm-700 nm of the bokeh filter membrane at a maximum effective diameter of the substrate is R4070-p, and the following condition is satisfied:
0%≤R4070-p≤3.00%.

10. The bokeh filter membrane of claim 1, wherein when a total membrane thickness of the gradient thickness absorbing membrane is 40 nm to 60 nm, an average reflectance in a wavelength range of 400 nm-500 nm of the bokeh filter membrane is R4050-5, and the following condition is satisfied:
0%≤R4050-5≤0.70%.

11. The bokeh filter membrane of claim 1, wherein when a total membrane thickness of the gradient thickness absorbing membrane is 85 nm to 115 nm, an average reflectance in a wavelength range of 450 nm-550 nm of the bokeh filter membrane is R4555-10, and the following condition is satisfied:
0%≤R4555-10≤0.82%.

12. The bokeh filter membrane of claim 1, wherein when a total membrane thickness of the gradient thickness absorbing membrane is 180 nm to 220 nm, an average reflectance in a wavelength range of 550 nm-700 nm of the bokeh filter membrane is R5570-20, and the following condition is satisfied:
0%≤R5570-20≤1.10%.

13. The bokeh filter membrane of claim 1, wherein when a total membrane thickness of the gradient thickness absorbing membrane is 450 nm to 550 nm, an average reflectance in a wavelength range of 400 nm-700 nm of the bokeh filter membrane is R4070-50, and the following condition is satisfied:
0%≤R4070-50≤1.00%.

14. The bokeh filter membrane of claim 1, wherein an average transmittance in a wavelength range of 400 nm-700 nm of the bokeh filter membrane at a maximum effective diameter of the substrate is T4070-p, and the following condition is satisfied:
T4070-p≤3.00%.

15. The bokeh filter membrane of claim 1, wherein an average transmittance in a wavelength range of 400 nm-700 nm of the bokeh filter membrane at a maximum effective diameter of the substrate is T4070-p; an average transmittance in the wavelength range of 400 nm-700 nm of the bokeh filter membrane at the center of the substrate is T4070-c; when a total membrane thickness of the gradient thickness absorbing membrane is 40 nm to 60 nm, an average transmittance in the wavelength range of 400 nm-700 nm of the bokeh filter membrane is T4070-5; when the total membrane thickness of the gradient thickness absorbing membrane is 180 nm to 220 nm, the average transmittance in the wavelength range of 400 nm-700 nm of the bokeh filter membrane is T4070-20; and the following conditions are satisfied:
100×(T4070-p/T4070-c)≤3.00;
T4070-5/T4070-c≤1.20; and
T4070-20/T4070-c≤0.80.

16. An imaging optical lens assembly, comprising:
the bokeh filter membrane of claim 1;
at least one optical lens element; and
at least one optical element;
wherein at least one surface of the at least one optical lens element and the at least one optical element comprises the bokeh filter membrane.

17. The imaging optical lens assembly of claim 16, further comprising:
an aperture stop, wherein the at least one optical element is located at an object side or an image side of the aperture stop, and at least one surface of the at least one optical element comprises the bokeh filter membrane.

18. The imaging optical lens assembly of claim 17, wherein the at least one optical element comprises a first optical element and a second optical element, the first optical element is located at the object side of the aperture stop, the second optical element is located at the image side of the aperture stop, and at least one surface of the first optical element and at least one surface of the second optical element comprises the bokeh filter membrane.

19. The imaging optical lens assembly of claim 18, wherein a distance along an optical axis between the surface comprising the bokeh filter membrane of the first optical element and the aperture stop is equal to a distance along the optical axis between the aperture stop and the surface comprising the bokeh filter membrane of the second optical element.

20. The imaging optical lens assembly of claim 16, further comprising:
an aperture stop, wherein at least one surface of the at least one optical element comprises the bokeh filter membrane, and the at least one surface is disposed on a position of the aperture stop.

21. The imaging optical lens assembly of claim 16, further comprising:
an aperture stop, wherein the at least one optical lens element is located at an object side or an image side of the aperture stop, and at least one surface of the at least one optical lens element comprises the bokeh filter membrane.

22. The imaging optical lens assembly of claim 21, wherein the at least one optical lens element comprises a first optical lens element and a second optical lens element, the first optical lens element is located at the object side of the aperture stop, the second optical lens element is located at the image side of the aperture stop, and at least one surface of the first optical lens element and at least one surface of the second optical lens element comprise the bokeh filter membrane.

23. The imaging optical lens assembly of claim 22, wherein a distance along an optical axis between the surface comprising the bokeh filter membrane of the first optical lens element and the aperture stop is equal to a distance along the optical axis between the aperture stop and the surface comprising the bokeh filter membrane of the second optical lens element.

24. An imaging apparatus, comprising:
the imaging optical lens assembly of claim 16; and
an image sensor disposed on an image surface of the imaging optical lens assembly.

25. An electronic device, comprising:
the imaging apparatus of claim 24.

26. A bokeh filter membrane, which is disposed on a surface of a substrate, comprising:
a gradient thickness absorbing membrane; and
an anti-reflection membrane comprising a high-and-low refraction membrane and a gradient refraction membrane;
wherein a transmittance of the substrate at a center thereof is greater than a transmittance of the substrate at a peripheral region thereof;
wherein the gradient thickness absorbing membrane comprises a first gradient thickness absorbing membrane and a second gradient thickness absorbing membrane, the second gradient thickness absorbing membrane is farther away from the substrate than the first gradient thickness absorbing membrane, and the gradient refraction membrane is farther away from the substrate than the second gradient thickness absorbing membrane;
wherein the gradient refraction membrane comprises a plurality of pores, and the pores away from the substrate are relatively larger than the pores close to the substrate;
wherein a main material of the gradient refraction membrane is metal oxide;
wherein a membrane thickness of the first gradient thickness absorbing membrane at a maximum effective diameter is Tab1, a membrane thickness of the second gradient thickness absorbing membrane at the maximum effective diameter is Tab2, a total membrane thickness of the bokeh filter membrane at the maximum effective diameter is TKP, the following conditions are satisfied:
0.60≤Tab1/Tab2≤1.80; and
1250.0 nm<TKP.

27. The bokeh filter membrane of claim 26, wherein a membrane thickness of the gradient refraction membrane is TNG, the following condition is satisfied:
115.0 nm≤TNG≤1000.0 nm.

28. The bokeh filter membrane of claim 27, wherein the membrane thickness of the gradient refraction membrane is TNG, the following condition is satisfied:
118.0 nm≤TNG≤350.0 nm.

29. The bokeh filter membrane of claim 26, wherein a refractive index of the first gradient thickness absorbing membrane is Nab1, a refractive index of the second gradient thickness absorbing membrane is Nab2, and the following condition is satisfied:
Nab1>Nab2.

30. The bokeh filter membrane of claim 26, wherein when a total membrane thickness of the gradient thickness absorbing membrane is 40 nm to 60 nm, an average reflectance in a wavelength range of 400 nm-500 nm of the bokeh filter membrane is R4050-5, and the following condition is satisfied:
0%<R4050-5<0.70%.

31. The bokeh filter membrane of claim 26, wherein when a total membrane thickness of the gradient thickness absorbing membrane is 85 nm to 115 nm, an average reflectance in a wavelength range of 450 nm-550 nm of the bokeh filter membrane is R4555-10, and the following condition is satisfied:
0%<R4555-10<0.82%.

32. The bokeh filter membrane of claim 26, wherein when a total membrane thickness of the gradient thickness absorbing membrane is 180 nm to 220 nm, an average reflectance in a wavelength range of 550 nm-700 nm of the bokeh filter membrane is R5570-20, and the following condition is satisfied:
0%<R5570-20<1.10%.

33. The bokeh filter membrane of claim 26, wherein when a total membrane thickness of the gradient thickness absorbing membrane is 450 nm to 550 nm, an average reflectance in a wavelength range of 400 nm-700 nm of the bokeh filter membrane is R4070-50, and the following condition is satisfied:
0%<R4070-50<1.00%.

34. An imaging optical lens assembly, comprising:
the bokeh filter membrane of claim 26;
at least one optical lens element; and
at least one optical element;
wherein at least one surface of the at least one optical lens element and the at least one optical element comprises the bokeh filter membrane.
